(19) United States
(12) Patent Application Publication
(10) Pub. No.: US 2026/0304054 A1
(43) Pub. Date: Oct. 1, 2026

(54) MACHINE LISTENER BASED AUDIO STREAMING QUALITY

(71) Applicant: DOLBY INTERNATIONAL AB, Dublin (IE)

(72) Inventors: Janusz KLEJSA, Solna (SE); Arijit BISWAS, Schwaig bei Nuernberg (DE); Ludvig Carl Henrik NORING, Hägersten (SE); Guanxin JIANG, Nuremberg (DE); Lars VILLEMOES, Stockholm (SE)

(73) Assignee: DOLBY INTERNATIONAL AB, Dublin (IE)

(21) Appl. No.: 19/477,274

(22) PCT Filed: Apr. 23, 2024
(86) PCT No.: PCT/EP2024/061092

§ 371 Date: Oct. 21, 2025

Related U.S. Application Data
(60) Provisional application No. 63/497,941, filed on Apr. 24, 2023.

(30) Foreign Application Priority Data
Jun. 28, 2023 (EP) 23181973.1

(51) Int. Cl. H04R 29/00; G10L 19/008; G10L 19/02

(52) U.S. Cl. CPC H04R 29/008; G10L 19/008; G10L 19/02

(57) ABSTRACT

A method of evaluating playout performance in an adaptive streaming environment is provided. The method includes obtaining playout-related information from a streaming client; estimating a representation of a test audio signal based on the playout-related information, wherein the test audio signal is an audio signal played out by the streaming client; and determining, using an audio quality assessment algorithm, an estimate of an audio quality of the test audio signal based on the estimated representation of the test audio signal. Also provided is a method of providing playout-related information at a streaming client, as well as corresponding apparatus, programs, and computer-readable storage media.

### CROSS-REFERENCE TO RELATED APPLICATIONS

This application claims the benefit of priority from U.S. Provisional Application Ser. No. 63/497,941, filed on 24 Apr. 2023, and European Patent Application No. 23181973.1 filed on 28 Jun. 2023, each of which is incorporated by reference herein in its entirety.

### TECHNICAL FIELD

The present disclosure relates to techniques for evaluating playout performance in an adaptive streaming environment, and in relation thereto, to techniques for configuring a deep neural network (DNN) for estimating indications of a subjective listening score for a test audio signal.

### BACKGROUND

Algorithms for objective quality assessment of coding schemes can be divided into two categories. There are so-called intrusive algorithms, which require that a reference signal is provided in addition to the test signal, and there are also non-intrusive algorithms, which only analyze the test signal. In general, intrusive algorithms work better than non-intrusive algorithms. For example, in the context of lossy coding it may be difficult to assess the performance of a codec without the reference, since an artistic intent is unknown in this situation (e.g., a bandlimited audio signal could be a result of a deliberate processing step applied in content production rather than an artifact from a codec). Furthermore, any metrics provided by a non-intrusive quality assessment tool may be hard to interpret, as such tools typically lack grounding in well-established subjective quality assessment methodologies. For example, a Multi-Stimulus Test with Hidden Reference and Anchor (MUSHRA) test would be commonly used to evaluate audio codecs, and it involves usage of the reference signal.

Objective quality assessment may be of particular relevance in adaptive streaming environments where a quality (e.g., bitrate) of delivered content can be dynamically adjusted. What is of interest here is the playout audio quality at respective streaming clients. Intrusive algorithms however are not applicable in this case, as the streaming clients typically do not have access to reference signals.

Further, listener scores achieved in listening tests such as MUSHRA tests could be predicted by a system which takes the signal under test and the reference signal as inputs.

For a given pair of input signals, there will be a certain degree of variability in the listener scores and there is value in capturing that aspect of the data for automated estimation of quality of experience, for example in entertainment delivery systems. In an actual subjective MUSHRA test with multiple listeners, the mean and standard deviation of the listener scores can be computed. The standard deviation can then be converted to a confidence interval given the number of listeners and a statistical model.

However, current automated implementations of subjective listening test such as MUSHRA tests merely provide a mean value of the MUSHRA score and cannot provide an idea of variability of subjective listening scores that would be obtained from a population of test listeners.

Thus, there is a need for improvements in assessing audio quality in adaptive streaming environments. There is further need for improvements in automated predictions of subjective listening scores. There is particular need for techniques that can provide an estimate of a variability of subjective listening scores in automated solutions.

### SUMMARY

In view of at least some of these needs, the present disclosure provides methods and apparatus for configuring a deep neural network (DNN) for estimating an indication of a subjective listening score, methods for estimating an indication of a subjective listening score using a DNN, DNNs, as well as corresponding apparatus, programs, and computer-readable storage media.

The present disclosure further provides methods and apparatus for evaluating playout performance in an adaptive streaming environment, methods of providing playout-related information, as well as corresponding apparatus, programs and computer-readable storage media.

An aspect of the present disclosure relates to a method of configuring a DNN for estimating an indication of a subjective listening score for an audio signal (e.g., test audio signal). The method may be a method of training the DNN, for example. The listening score may be a score according to a listening test performed according to a predefined listening test methodology. The predefined listening test methodology may be a standardized listening test methodology. Further, the listening test may apply a predefined test metric and/or test scenario. The method may include providing an output stage of the DNN to generate the indication of the listening score. The method may further include training the DNN by, in a training epoch among a plurality of training epochs, inputting one or more training data items, each indicative of a respective value of the listening score. Training the DNN may further include, in the training epoch, determining respective indications of the listening score based on the one or more training data items. Training the DNN may further include, in the training epoch, determining respective loss values for the one or more training data items by evaluating a loss function. Here, the loss function may depend on the indication of the listening score. Training the DNN may yet further include, in the training epoch, adjusting one or more internal parameters of the DNN based on the determined loss values. The internal parameters of the DNN may be model parameters, for example, such as coefficients (e.g., filter coefficients) of a plurality of layers of the DNN.

Accordingly, the DNN is trained not on mean values of the subjective listening score, but rather on individual listening scores. This allows to adapt the DNN for predicting parameters beyond the mean listening score, including, for example, a probability distribution, standard deviation, and/or confidence interval of the listening score.

In some embodiments, the indication of the listening score may relate to a probability distribution of the listening score, with the output stage being adapted for generating the probability distribution of the listening score. The probability distribution may emulate listening scores obtained by a plurality of listening tests for the audio signal. The plurality of listening tests emulated by the probability distribution may be independent listening tests. Further, the probability distribution may be parameterized by two or more parameters of the probability distribution. Then, determining respective indications of the listening score based on the one or more training data items may include determining respective parameters of the probability distribution based on the one or more training data items. Determining the parameters of the probability distribution may be based at least in part on the value of the subjective listening score. Further, determining the parameters of the probability distribution may be based on a current state of the DNN, for example the current values of internal parameters of the DNN. The loss function may depend on the parameters of the distribution.

In some embodiments, training the DNN may be based on a maximum likelihood principle.

In some embodiments, the loss function may relate to a negative log likelihood, NLL, loss.

In some embodiments, the negative log likelihood loss may be given by L_{NLL}=−log p_{θ}(s|x, y), where p_{θ}(s|x, y) is the probability distribution for test score s given a representation of the audio signal y and a representation of a reference audio signal x for the audio signal y, and θ indicates the internal parameters of the DNN.

Using the maximum likelihood principle, or correspondingly, negative log likelihood loss allows to efficiently train the DNN based on individual listening scores to provide an indication of listening scores that could be expected in an actual subjective listening test with multiple listeners.

In some embodiments, the probability distribution may relate to a Gaussian distribution parameterized by a mean μ and a variance σ². Then, the loss function L_{Gauss} may be given by

$${L}_{Gauss} = log σ + \frac{{( s - μ )}^{2}}{2 {σ}^{2}} + c ,$$

where c is a constant and s is the subjective listening score. The constant c may be given by

$$c = \frac{1}{2} log 2 π ,$$

for example.

In some embodiments, the probability distribution may relate to a logistic distribution parameterized by a mean u and a scale a. Then, the loss function L_{logistic} may be given by

$${L}_{logistic} = log a + 2 log sech ( \frac{s - μ}{2 a} ) + c ,$$

where c is a constant and s is the subjective listening score. The constant c may be given by c=log 4, for example.

Both these parameterizations of the probability distribution have been found to provide for efficient training at the training stage, and meaningful output at inference.

In some embodiments, the training data item may be further indicative of a representation of the audio signal and a representation of a reference audio signal for the audio signal.

Accordingly, the DNN under consideration can be configured to automate an intrusive listening test, with the particular characteristics and advantages listed above.

In some embodiments, the representation of the audio signal and the representation of the reference audio signal may relate to Gammatone spectrograms.

Gammatone spectrograms are auditory features specifically adapted to human hearing and perception and therefore allow for achieving meaningful results at reduced computational complexity.

In some embodiments, the predefined listening test may be a Multi-Stimulus Test with Hidden Reference and Anchor (MUSHRA) listening test, for example as standardized under ITU-R recommendation BS.1534.

In some embodiments, the DNN may implement a generative model.

Another aspect of the disclosure relates to a method of estimating an indication of a subjective listening score for an audio signal using a DNN. The listening score may be a score according to a predefined listening test. The DNN may include an input stage for receiving a representation of the audio signal and a representation of a reference audio signal for the audio signal. The DNN may further include a plurality of layers for performing processing based on the representation of the audio signal and the representation of the reference audio signal. Processing by the plurality of layers may be further based on a current state of the DNN, for example the current values of internal parameters of the DNN. The DNN may yet further include an output stage, connected to a last one of the plurality of layers, for generating the indication of the listening score. The method may include inputting the representation of the audio signal and the representation of the reference audio signal to the input stage. The method may further include determining a representation of the indication of the listening score based on an output of the output stage.

In some embodiments, the indication of the listening score may relate to a probability distribution of the listening score, with the output stage of the DNN being adapted for generating the probability distribution of the listening score. The probability distribution may emulate listening scores obtained by a plurality of (subjective) listening tests for the audio signal. The probability distribution may be parameterized by two or more parameters of the probability distribution.

In some embodiments, determining the representation of the probability distribution may include determining at least one of a mean, a standard deviation, and a confidence interval from the output of the output stage.

In some embodiments, the confidence interval may be determined based on the output of the output stage and a number (e.g., count) of listeners to the listening test to be emulated.

In some embodiments, the probability distribution may relate to a Gaussian distribution parameterized by a mean u and a variance σ² or to a logistic distribution parameterized by a mean u and a scale a.

In some embodiments, the representation of the audio signal and the representation of the reference audio signal may relate to Gammatone spectrograms.

In some embodiments, the predefined listening test may be a MUSHRA listening test.

Another aspect of the disclosure relates to a DNN for estimating an indication of a subjective listening score for an audio signal. The listening score may be a score according to a predefined listening test. The DNN may include an input stage for receiving a representation of the audio signal and a representation of a reference audio signal for the audio signal. The DNN may further include a plurality of layers for performing processing based on the representation of the audio signal and the representation of the reference audio signal. Processing by the plurality of layers may be further based on a current state of the DNN, for example the current values of internal parameters of the DNN. The DNN may yet further include an output stage, coupled to a last one of the plurality of layers, for generating the indication of the listening score.

In some embodiments, the DNN may have been configured by training the DNN by, in a training epoch among a plurality of training epochs, inputting one or more training data items, each indicative of a respective value of the listening score. Training the DNN, in the training epoch, may further include determining respective indications of the listening score based on the one or more training data items. Training the DNN, in the training epoch, may further include determining respective loss values for the one or more training data items by evaluating a loss function. This loss function may depend on the indication of the listening score.

Training the DNN, in the training epoch, may yet further include adjusting one or more internal parameters of the DNN based on the determined loss values. Configuring the DNN may involve or correspond to obtaining internal parameters of the DNN by training the DNN.

In some embodiments, the indication of the listening score may relate to a probability distribution of the listening score, with the output stage of the DNN being adapted for generating the probability distribution of the listening score. The probability distribution may emulate listening scores obtained by a plurality of listening tests for the audio signal. Further, the probability distribution may be parameterized by two or more parameters of the probability distribution.

In some embodiments, determining respective indications of the listening score based on the one or more training data items may include determining respective parameters of the probability distribution based on the one or more training data items. Determining the parameters of the probability distribution may be based at least in part on the value of the subjective listening score. Further, determining the parameters of the probability distribution may be based on a current state of the DNN, for example the current values of internal parameters of the DNN. The loss function may depend on the parameters of the distribution.

In some embodiments, the probability distribution may relate to a Gaussian distribution parameterized by a mean μ and a variance σ² or to a logistic distribution parameterized by a mean μ and a scale a.

In some embodiments, the representation of the audio signal and the representation of the reference audio signal may relate to (one or more) Gammatone spectrograms.

In some embodiments, the predefined listening test may be a MUSHRA listening test.

Another aspect of the disclosure relates to an apparatus comprising a processor and a memory coupled to the processor, and storing instructions for the processor. The processor may be adapted to carry out the methods according to the foregoing aspects and their embodiments.

Another aspect of the disclosure relates to an apparatus comprising a processor and a memory coupled to the processor, and storing instructions for the processor. The processor may be adapted to implement DNNs according to the foregoing aspects and their embodiments.

Another aspect of the disclosure relates to a program comprising instructions that, when executed by a processor, cause the processor to carry out the methods according to the foregoing aspects and their embodiments.

Another aspect of the disclosure relates to a program comprising instructions that, when executed by a processor, cause the processor to implement the DNN according to the foregoing aspects and their embodiments.

Another aspect of the disclosure relates to a computer-readable storage medium storing any of the aforementioned programs.

Another aspect of the disclosure relates to a method of evaluating playout performance in an adaptive streaming environment. Playout performance may relate to (subjective) playout quality, for example. The method may include obtaining playout-related information from a streaming client. The playout-related information may include, correspond to, or be in the form of metadata, for example. The method may further include estimating a representation of a test audio signal based on the playout-related information. The test audio signal may be an audio signal played out by the streaming client. Estimating the representation of the test audio signal may involve or correspond to reconstructing the test audio signal or a representation thereof. The representation may relate to a set of features or spectrograms of the test audio signal, for example. The method may yet further include determining, using an audio quality assessment algorithm, an estimate of an audio quality of the test audio signal based on the estimated representation of the test audio signal. The audio quality assessment algorithm may be an objective audio quality assessment algorithm. Further, the audio quality assessment algorithm may emulate an intrusive audio quality test (e.g., listening test), such as a MUSHRA test, for example. It is understood that the estimated representation of the test audio signal is in a form suitable for input to the audio quality assessment algorithm. For example, the representation of the test audio signal may relate to a predefined number of segments to accommodate for requirements of the audio quality assessment algorithm relating to a time span covered by input audio signals or representations thereof.

Thereby, the proposed method allows to estimate results of an intrusive listening test without requiring knowledge of the reference signal at the streaming client. Configured as described above, the intrusive listening test can be performed at a network node removed from the streaming client. The streaming client is only required to provide lightweight metadata to the network node performing the test. Both, a version of the played out audio as well as a reference for the played out audio can be derived at said network node, using the metadata. As a result, the proposed method can yield a meaningful and readily interpretable estimate of an audio quality of audio content played out by the streaming client without significant additional signaling overhead to or from the streaming client.

In some embodiments, the method may further include generating a representation of a reference audio signal for the test audio signal. This may include obtaining (e.g., receiving) audio content or a representation thereof from a content repository. It is understood that the representation of the reference audio signal is in a form suitable for input to the audio quality assessment algorithm. For example, the representation of the reference audio signal may relate to a predefined number of segments to accommodate for requirements of the audio quality assessment algorithm relating to a time span covered by input audio signals or representations thereof.

In some embodiments, the method may further include obtaining, from the streaming client, an indication of audio content processed by the streaming client. The indication of the audio content may comprise an identifier, such as a file name, etc. of the audio content, a bitrate level of the audio content, and/or information on a segmentation of the audio content. The indication of audio content may be used to determine a sequence of audio segments received by the streaming client. The audio content processed by the streaming client may be audio content received by the streaming client, for example from a content delivery network.

In some embodiments, estimating the representation of the test audio signal may be further based on the indication of the audio content.

In some embodiments, generating the representation of the reference audio signal may be based on the indication of the audio content. This may comprise obtaining (e.g., receiving) audio content or a representation thereof from a content repository, based on the indication of the audio content that is played out by the streaming client.

In some embodiments, the playout-related information may include bitrate information indicating a bitrate of the audio signal played out by the streaming client. Then, estimating the representation of the test audio signal may be based on the bitrate information. The bitrate information may be provided for each of a plurality of segments of the audio signal played out by the streaming client.

In some embodiments, the audio quality assessment algorithm may use a set of pretrained models for audio quality assessment. Generating the estimate of the audio quality may include selecting a pretrained model among the set of pretrained models based on the playout-related information.

Thereby, it can be ensured that the optimal model is used for each relevant situation (e.g., a model particularly trained for the situation), thereby improving reliability of the estimation of playout performance.

In some embodiments, the playout related information may include information relating to a playout device associated with the streaming client. Then, the pretrained model may be selected based on the information relating to the playout device. The information relating to the playout device may include an indication of the playout device (e.g., headphones, soundbar, discrete speakers, etc.) and/or an indication of characteristics of the playout conditions (e.g., SNR, etc.).

Accordingly, an appropriate model for audio quality assessment may be used for each of a plurality of different playout device configurations, thereby improving reliability of the estimation of playout performance.

In some embodiments, the audio quality assessment algorithm may be implemented by a deep neural network, DNN, for estimating an indication of a subjective listening score for the representation of a test audio signal as the estimate of the audio quality. The listening score may be a score according to a predefined listening test. The DNN may include an input stage for receiving the representation of the test audio signal and a representation of a reference audio signal for the test audio signal. The DNN may further include a plurality of layers for performing processing based on the representation of the test audio signal and the representation of the reference audio signal. The DNN may yet further include an output stage for generating the indication of the listening score.

In some embodiments, the DNN may have been configured by training the DNN by, in a training epoch among a plurality of training epochs, inputting one or more training data items, each indicative of a respective value of the listening score. The DNN may have further been configured by, in the training epoch, determining respective indications of the listening score based on the one or more training data items. The DNN may have further been configured by, in the training epoch, determining respective loss values for the one or more training data items by evaluating a loss function, wherein the loss function depends on the indication of the listening score. The DNN may have yet further been configured by, in the training epoch, adjusting one or more internal parameters of the DNN based on the determined loss values.

In some embodiments, the method may be implemented at a different network node than the streaming client.

In some embodiments, the representation of the estimate of the test audio signal may relate to one or more Gammatone spectrograms.

In some embodiments, the representation of the reference audio signal may relate to one or more Gammatone spectrograms.

In some embodiments, the method may further include outputting the estimate of the audio quality of the test audio signal to a network node different from a network node associated with the streaming client. The network nodes may be network nodes in a cloud-based framework, for example.

In some embodiments, the estimate of the audio quality of the test audio signal may be output to a network node for performing encoding and/or packaging of the audio content. Then, the method may further include optimizing the encoding and/or packaging based on the estimate of the audio quality of the test audio signal.

In some embodiments, the method may further include determining an optimal number of quality levels in a bitrate ladder for distribution by a content delivery network, based on the estimate of the audio quality of the test audio signal. This may involve inputting the estimate of the audio quality of the test audio signal to a utility function used for determining the optimal number of quality levels, for example.

In some embodiments, the method may further include determining a configuration and/or set of coding tools based on the estimate of the audio quality of the test audio signal.

In some embodiments, the method may further include determining estimates of audio quality of test audio signal for streaming clients in each of a plurality of populations of streaming clients. The method may yet further include comparing the estimates of audio quality determined for the plurality of populations of streaming clients.

This may allow to compare different content delivery methods and/or playout methods for determining an optimal delivery method and/or playout method.

Another aspect of the disclosure relates to a method of providing playout-related information at a streaming client that processes audio content in an adaptive streaming environment. The method may include generating the playout-related information by one or more of: analyzing a playout buffer associated with the streaming client for determining bitrate information indicating a bitrate of segments of an audio signal played out by the streaming client; analyzing manifest information associated with the audio content; and analyzing characteristics of a playout device associated with the streaming clients. The method may further include outputting the playout-related information to a network node different from a network node associated with the streaming client.

Another aspect of the disclosure relates to an apparatus comprising a processor and a memory coupled to the processor, and storing instructions for the processor. The processor may be adapted to carry out the methods according to any one of the two preceding aspects and their embodiments.

Another aspect of the disclosure relates to a program comprising instructions that, when executed by a processor, cause the processor to carry out the methods according to the two aforementioned aspects and their embodiments.

Another aspect of the disclosure relates to a computer-readable storage medium storing the program of the preceding aspect.

It should be noted that the methods and systems including its preferred embodiments as outlined in the present disclosure may be used stand-alone or in combination with the other methods and systems disclosed in this document. Furthermore, all aspects of the methods, apparatus, and systems outlined in the present disclosure may be arbitrarily combined.

In particular, the features of the claims may be combined with one another in an arbitrary manner.

It will be appreciated that apparatus features and method steps may be interchanged in many ways. In particular, the details of the disclosed method(s) can be realized by the corresponding apparatus, and vice versa, as the skilled person will appreciate. Moreover, any of the above statements made with respect to the method(s) (and, e.g., their steps) are understood to likewise apply to the corresponding apparatus (and, e.g., their blocks, stages, units), and vice versa.

### BRIEF DESCRIPTION OF THE DRAWINGS

The invention is explained below in an exemplary manner with reference to the accompanying drawings, wherein like numbers indicate like elements, and where

FIG. 1 is a block diagram schematically illustrating an example of a framework for evaluating playout performance in an adaptive streaming environment according to embodiments of the disclosure;

FIG. 2 is a flowchart illustrating an example of a method of evaluating playout performance in an adaptive streaming environment according to embodiments of the disclosure;

FIG. 3A is a block diagram schematically illustrating playout analysis and generation of playout-related information at a streaming client according to embodiments of the disclosure;

FIG. 3B is a block diagram schematically illustrating model selection for evaluating playout performance in accordance with embodiments of the disclosure;

FIG. 4A and FIG. 4B are flowcharts illustrating an example of a method of generating playout-related information in accordance with embodiments of the disclosure;

FIG. 5 is a block diagram schematically illustrating an example of evaluation of playout performance using precomputed data according to embodiments of the disclosure;

FIG. 6 schematically illustrates an example of a graphical user interface for representing playout performance according to embodiments of the disclosure;

FIG. 7 is a flowchart illustrating an example of using the evaluated playout performance for comparing populations of streaming clients according to embodiments of the disclosure;

FIG. 8 is a block diagram schematically illustrating an example of a framework for comparing different content delivery networks according to embodiments of the disclosure;

FIG. 9 is a block diagram schematically illustrating an example of a framework for comparing different content delivery methods or playout methods according to embodiments of the disclosure;

FIG. 10 is a block diagram schematically illustrating an example of a framework for optimizing encoding and/or packaging of content in an adaptive streaming environment according to embodiments of the disclosure;

FIG. 11 is a flowchart illustrating an example of a method of optimizing encoding and/or packaging of content in an adaptive streaming environment according to embodiments of the disclosure;

FIG. 12 is a block diagram schematically illustrating an example of configuring a DNN for estimating indications of subjective listening scores according to embodiments of the disclosure;

FIG. 13 and FIG. 14 are flowcharts illustrating examples of methods of configuring a DNN for estimating indications of subjective listening scores according to embodiments of the disclosure;

FIG. 15 is a flowchart illustrating an example of a method of estimating indications of subjective listening scores using a DNN according to embodiments of the disclosure;

FIG. 16 to FIG. 20 are diagrams illustrating examples of performance of trained or partially trained DNNs according to embodiments of the disclosure; and

FIG. 21 is a block diagram showing an example of an apparatus for performing methods or implementing DNNs according to embodiments of the disclosure.

### DETAILED DESCRIPTION

The present disclosure relates to techniques for estimating audio quality of played-out content in an adaptive streaming environment and to techniques for configuring (e.g., training) and using DNNs for estimating audio quality, which will be described in turn.

### Machine Listener-Based Audio Streaming Quality

Broadly speaking, part of the present disclosure relates to techniques (e.g., methods, apparatus, and systems) for performing objective quality testing of audio in the context of content streaming (e.g., adaptive streaming, in particular adaptive audio streaming), for example over the Internet. A system implementing such techniques may include a cloud-based service receiving playout-related information (e.g., playout-related parameters) from a client (streaming client) or a set of clients (i.e., population of clients) and then computing an objective quality score by emulating a subjective quality assessment test, for example according to the MUSHRA methodology (e.g., as standardized under ITU-R recommendation BS.1534).

The proposed techniques facilitate evaluation of audio quality from encoding to the actual client playout. They also allow to evaluate a population of clients in terms of the audio quality that is delivered to these clients.

Further, the proposed techniques can be used for monitoring of audio experience. The techniques can also be used to perform A/B testing (e.g., bucket testing or split-run testing) on real-world populations of streaming clients (e.g., for experiments comparing performance of bitrate ladders and/or codecs). The system can perform quality analysis in an online mode and an offline setting. In the online mode, the audio quality may be estimated in real-time according to the progress of streaming based on a feedback channel between a client and the service. In the offline setting, the service can first collect all parametric data from clients taking part in an experiment, and then perform the analysis according to that data.

Notably, the proposed techniques may apply the so-called generative machine listener described later in the present disclosure. As will be explained in more detail later, the generative machine listener is a neural network (e.g., DNN) trained to evaluate audio by comparing it to a reference signal and providing the evaluation result for example as a probability distribution with a mean value corresponding to the MUSHRA score and a confidence value corresponding to a confidence interval expected in a listening test performed on such material.

### Definitions

Intrusive quality assessment requires access to the reference signal and the test signal. Well-established subjective testing methodologies use this approach. There are non-intrusive quality methods, which only require access to the test signal. However, they are unreliable, and results may be difficult to interpret.

Objective quality assessment algorithm facilitates estimation of quality of experience for human observers without using human observers. For example, a generative machine listener performs objective quality assessment by predicting the quality scores that would be achieved in subjective testing with human observers. In particular, the machine listeners for example facilitates estimation of mean performance scores along with the associated confidence intervals.

Adaptive streaming is a content delivery method where the content is available in multiple quality versions, which are associated with different bitrates. The higher the bitrate the higher the quality is. A content player includes a policy that attempts to determine the highest possible bitrate that results in delivery of segments in time before they are due to play out. In other words, the adaptive streaming policy attempts to maximize the Quality of Experience (e.g., in a setting where content segments are being downloaded, inserted into a playout buffer, and played out), while maintaining the probability of depletion of the playout buffer below some reasonably low threshold (i.e., the probability of rebuffering remains small).

Bitrate ladder is a set of versions of the content that are associated with different quality versions of the content. The bitrates of content in the bitrate ladder are designed to facilitate streaming over diverse throughput scenarios (e.g., very low to very high throughput). An adaptive streaming policy will select an appropriate quality level from the bitrate ladder on a per-segment basis. Information about the bitrate ladder is typically supplied to the content player in a so-called manifest.

### DESCRIPTION OF EXAMPLE EMBODIMENTS

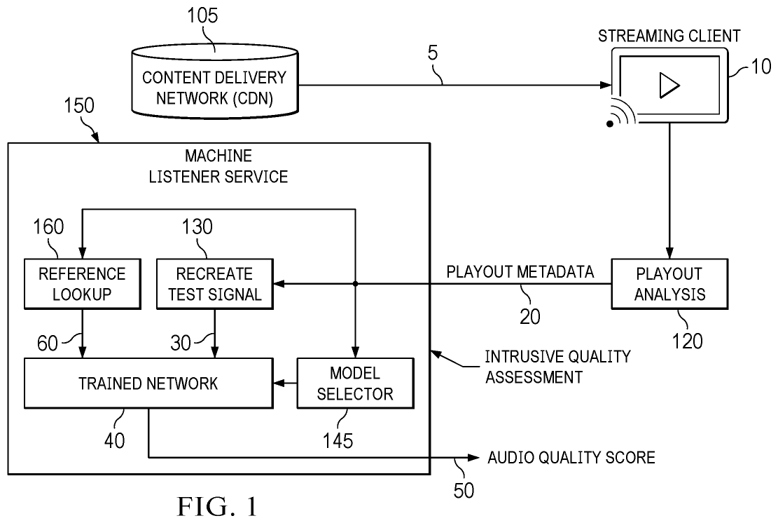

FIG. 1 depicts an example of a quality assessment service that incorporates a machine listener (e.g., as part of a quality assessment service) in a framework for adaptive streaming. The machine listener facilitates intrusive quality assessment of audio experience at the client, without a need to provide an uncoded reference to the client.

As noted above, using intrusive algorithms for quality assessment in (adaptive) streaming environments is hindered by the fact that streaming clients typically do not have access to reference signals. Providing the streaming clients with reference signals typically would require out-of-band placement of the reference signals, which is strongly disfavored by bandwidth limitations.

Embodiments of the present disclosure facilitate execution of an intrusive test for example within a cloud or network service, at a node (test node, network node) where the reference signal can be supplied. Instead of sending the client playout signal upstream to the test node, the test signal is reassembled at the test node based on lightweight playout-related metadata, which can be obtained by an instrumented client and then sent upstream to the service.

In the example of FIG. 1, the streaming client 10 receives coded audio content 5 (e.g., audio content or video content with associated audio content), for example via the Internet, from a Content Delivery Network (CDN) 105. The CDN 105 may provide different versions of given content, for example at different bitrates (e.g., using different settings within a predefined bitrate ladder), depending on streaming client configuration and/or network conditions, etc., The streaming client 10 on the other hand may be configured to employ adaptive bitrate control to request content at different bitrates for maximizing playout quality and/or user experience.

After appropriate decoding, the streaming client 10 plays out the audio content, for example in a segment-by-segment manner, via a playout buffer. At the same time, the streaming client 10 performs playout analysis, for example via playout analysis block 120, to generate playout-related information 20 (e.g., playout-related metadata, or playout metadata). In this sense, the streaming client 10 acts as, implements, or comprises an instrumented client that collects and forwards playout-related information 20. The playout-related information 20 is provided to or is retrieved by a quality assessment service 150 (e.g., machine listener service). In general, the playout-related information 20 may be said to be provided to or retrieved by a test node. Further, an indication of audio content processed by the streaming client 10 is provided to or is retrieved by the quality assessment service 150 (or test node), to enable the quality assessment service 150 to generate a reference signal relating to the content processed by the streaming client 10, for intrusive quality assessment. Here, the indication of the audio content may comprise an identifier, such as a file name such as a file name (e.g., file name of an audio segment), etc. of the audio content, a bitrate level of the audio content, and/or information on a (current) segmentation of the audio content. The indication of audio content may be used to determine a sequence of audio segments received and played out by the streaming client 10. The audio content processed by the streaming client 10 may be audio content received by the streaming client 10, for example from the CDN 105. The indication of the audio content may be obtained, for example, by intercepting a request of the streaming client 10 to the CDN 105.

The quality assessment service 150 may be in the form of a network service or cloud service. Further, the quality assessment service 150 may be configured for performing methods of evaluating playout performance in an adaptive streaming environment, such as method 200 described below, for example. To this end, the quality assessment service 150 may comprise a trained network 40 and a model selector 145 for selecting an appropriately trained model among a set of models based on the playout-related information 20. The quality assessment service 150 may further comprise a recreate test signal block 130 for estimating the test signal 30, and a reference lookup block 160 for estimating a reference signal 60 for the test signal 30.

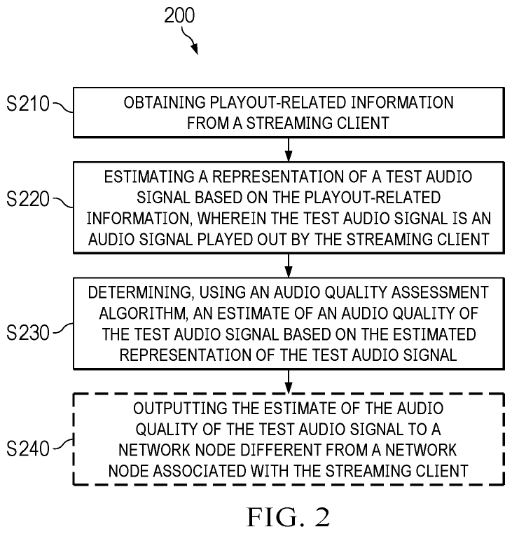

An example of a method 200 of evaluating playout performance in an adaptive streaming environment (e.g., by the quality assessment service 150 of FIG. 1) is illustrated in the flowchart of FIG. 2. Playout performance may relate to (subjective) playout quality, for example. Method 200 comprises steps S210 through S230 as well as an optional step S240. The method may be implemented at a different network node (e.g., test node) than the streaming client 10. Further, it may be implemented at a different network node than the CDN 105. Here, the network nodes may be network nodes in a cloud-based framework, for example.

At step S210, playout-related information is obtained from the streaming client. The playout-related information may include, correspond to, or be in the form of metadata, for example.

At step S220, a representation of the test audio signal is estimated based on the playout-related information. Here, the test audio signal is an audio signal played out by the streaming client. Estimating the representation of the test audio signal may involve or correspond to reconstructing the test audio signal or a representation thereof. The representation may relate to a set of features or spectrograms (e.g., Gammatone spectrograms) of the test audio signal, for example.

At step S230, an estimate of an audio quality of the test audio signal is determined, using an audio quality assessment algorithm, based on the estimated representation of the test audio signal. The audio quality assessment algorithm may be an objective audio quality assessment algorithm. Further, the audio quality assessment algorithm may emulate an intrusive audio quality test (e.g., listening test), such as a MUSHRA test, for example. It is understood that the estimated representation of the test audio signal is in a form suitable for input to the audio quality assessment algorithm. For example, the representation of the test audio signal may relate to a predefined number of segments to accommodate for requirements of the audio quality assessment algorithm relating to a time span covered by input audio signals or representations thereof.

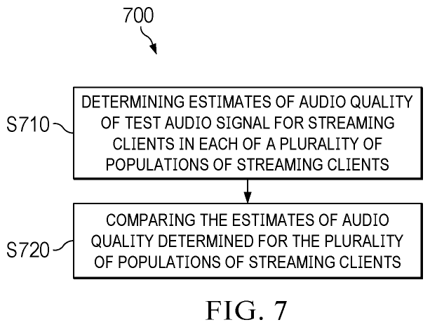

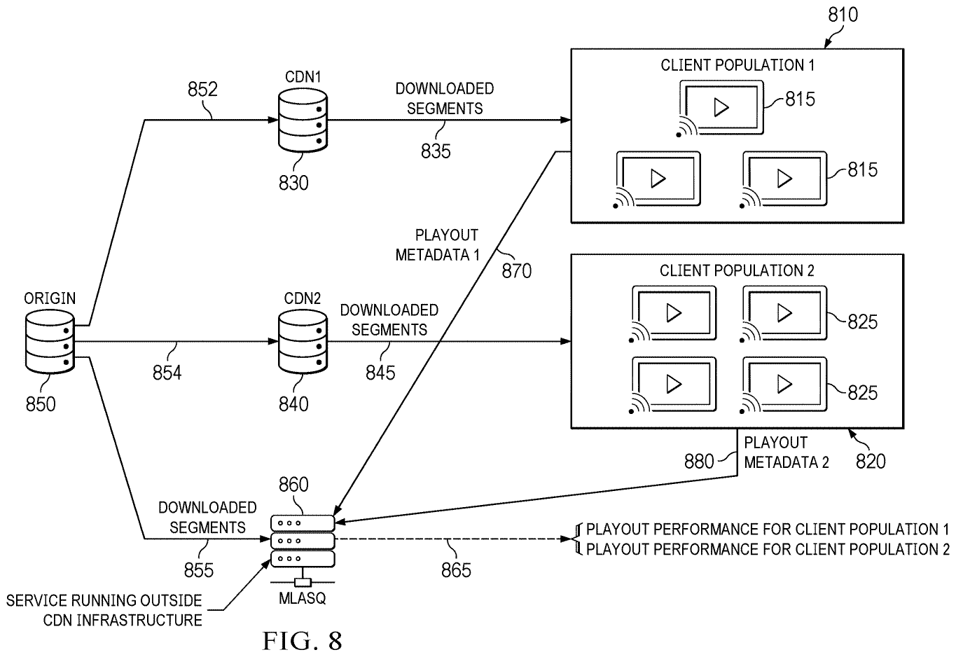

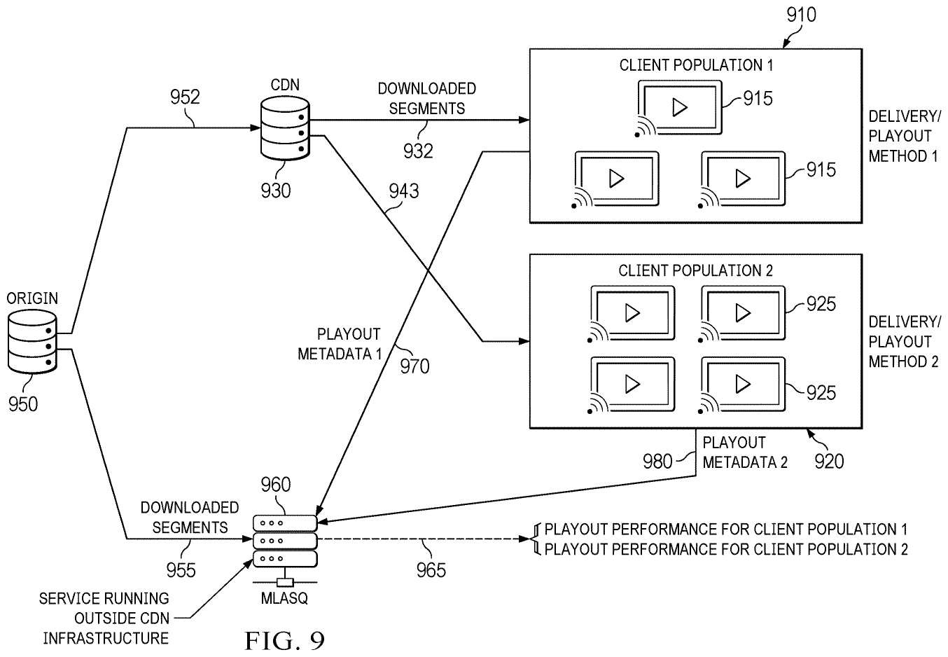

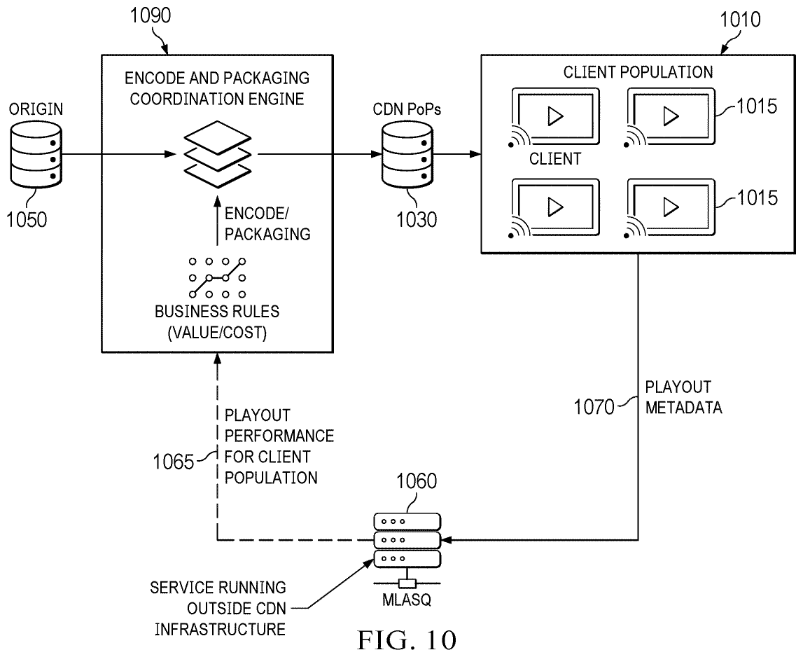

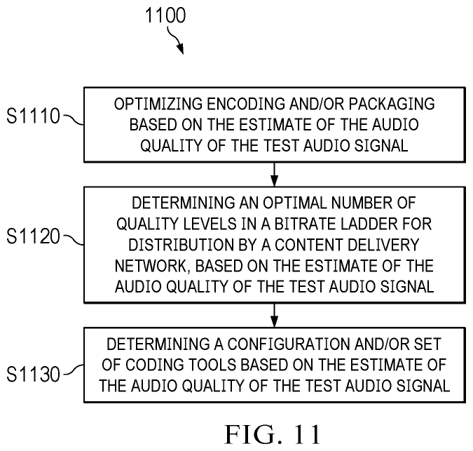

At step S240, which may be optional, the estimate of the audio quality of the test audio signal is output to a network node different from a network node associated with the streaming client. Non-limiting examples for using the estimate of the audio quality of the test audio signal will be described below with reference to FIG. 6, FIG. 7, FIG. 8, FIG. 9, FIG. 10, and FIG. 11.

Configured as described above, techniques according to the present disclosure use a quality assessment service (e.g., comprising a machine listener) as a cloud service for streaming quality evaluation. The quality assessment service (e.g., machine listener) is a component independent from the content delivery system and independent from the streaming client(s). The quality assessment service (e.g., machine listener) has the following properties:
It allows for performing intrusive quality testing of playout by the client device without need of supplying the reference signal to the client device.
It allows for performing objective quality evaluation that can emulate well established subjective testing methodology such as MUSHRA, for example.
By appropriate choice of the audio quality assessment algorithm, it can provide results as a probability distribution (e.g., MUSHRA score+confidence interval).

Potential applications and advantages of techniques according to embodiments of the present disclosure may include the following:
Techniques according to embodiments of the disclosure facilitate delivery with generic CDNs and allow to decouple the quality assessment system from the CDN infrastructure, which may be advantageous. Thus, CDN in general does not need to be involved in operating the machine listener service, and there is no need to store the reference signals in the CDN. The proposed techniques also facilitate multi-CDN delivery.
Techniques according to embodiments of the disclosure facilitate experimentation such as evaluation of scenarios where the quality estimates cannot be precomputed. One example of such scenarios is where the number of combinations of ABR ladder levels in a playout buffer and the number of distinct ways of playout (e.g., speaker in handheld device, headphone, discrete speakers) may be prohibitively large.
An example application of the system shown in the example of FIG. 1 is AB testing of bitrate ladders or codecs in real-world content delivery scenarios (e.g., on real populations of clients over real content delivery situations).

Configured as described above, systems and methods according to embodiments of the disclosure comprise means/steps to allow an emulation of an intrusive listening test (e.g., MUSHRA test) by operating the (generative) machine listener in a cloud, where the test signal is reconstructed (or partially reconstructed) within the service by using a feedback channel from an instrumented client sending playout-related metadata. Further, these systems and methods entail selection of an appropriate model used by the (generative) machine listener from a collection of pretrained models, based on the playout-related metadata.

In addition to the above, method 200 may also comprise a step (not shown in FIG. 2) of generating a representation of a reference audio signal for the test audio signal, for use by the audio quality assessment algorithm. This may include obtaining (e.g., receiving) audio content or a representation thereof from a content repository (or content origin in general). It is understood that the representation of the reference audio signal should be in a form suitable for input to the audio quality assessment algorithm. For example, the representation of the reference audio signal may relate to a predefined number of segments to accommodate for requirements of the audio quality assessment algorithm relating to a time span covered by input audio signals or representations thereof.

In addition to the playout-related information 20, the quality assessment service 150 may further require an indication (e.g., identification) of the audio content processed by the streaming client 10. Thus, method 200 may further comprise a step (not shown in FIG. 2) of obtaining, from the streaming client 10, an indication of audio content processed by the streaming client 10. As noted above, the indication of the audio content may comprise an identifier, such as a file name, etc. of the audio content, a bitrate level of the audio content, and/or information on a segmentation of the audio content. The indication of audio content may be used to determine a sequence of audio segments received by the streaming client 10. The audio content processed by the streaming client 10 may be audio content received by the streaming client 10, for example from the CDN 105. Then, with the indication of the audio content available, estimating the representation of the test audio signal at step S220 may be further based on the indication of the audio content. Further, also the generation of the representation of the reference audio signal may be based on the indication of the audio content. This may comprise obtaining (e.g., receiving) audio content or a representation thereof from a content repository, based on the indication of the audio content that is played out by the streaming client.

If the playout-related information 20 comprises bitrate information indicating a bitrate of the audio signal played out by the streaming client 10, estimating the representation of the test audio signal at step S220 may be based on the bitrate information. This bitrate information may be provided for each of a plurality of segments of the audio signal played out by the streaming client 10.

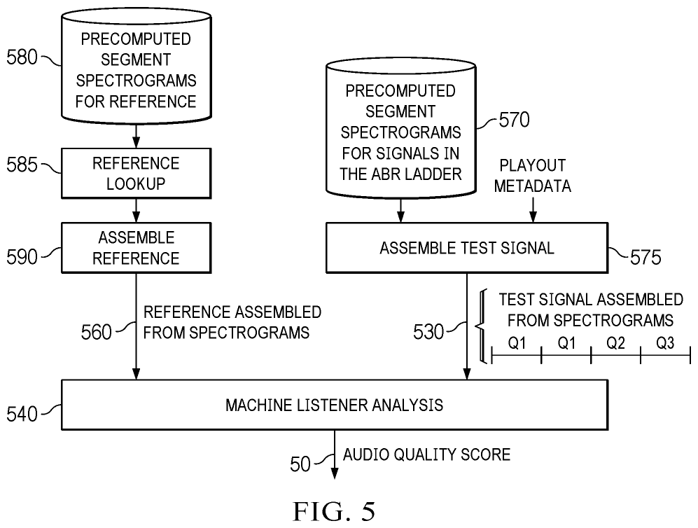

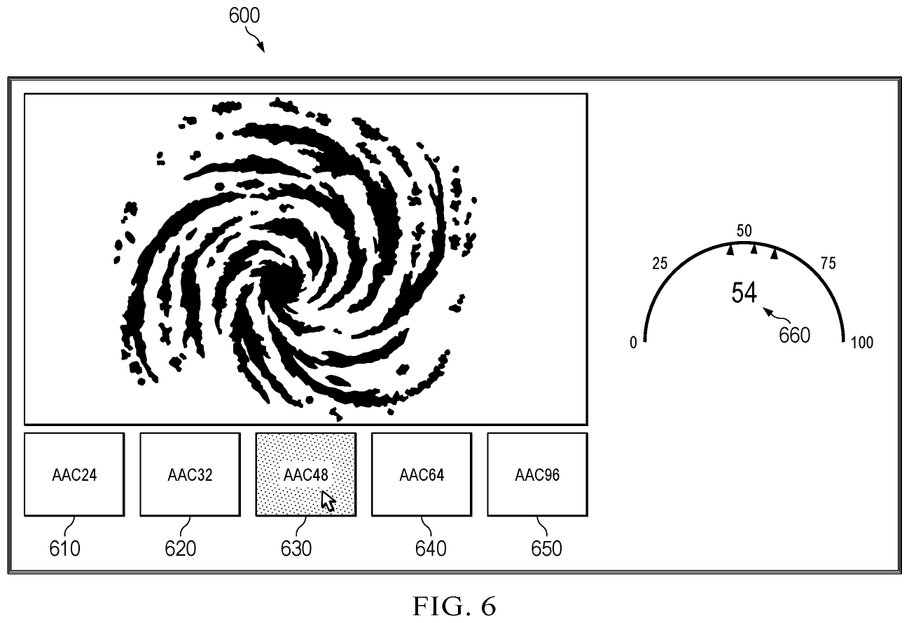

An example process for estimating representations of the test signal and the reference signal will be described below with reference to FIG. 5.

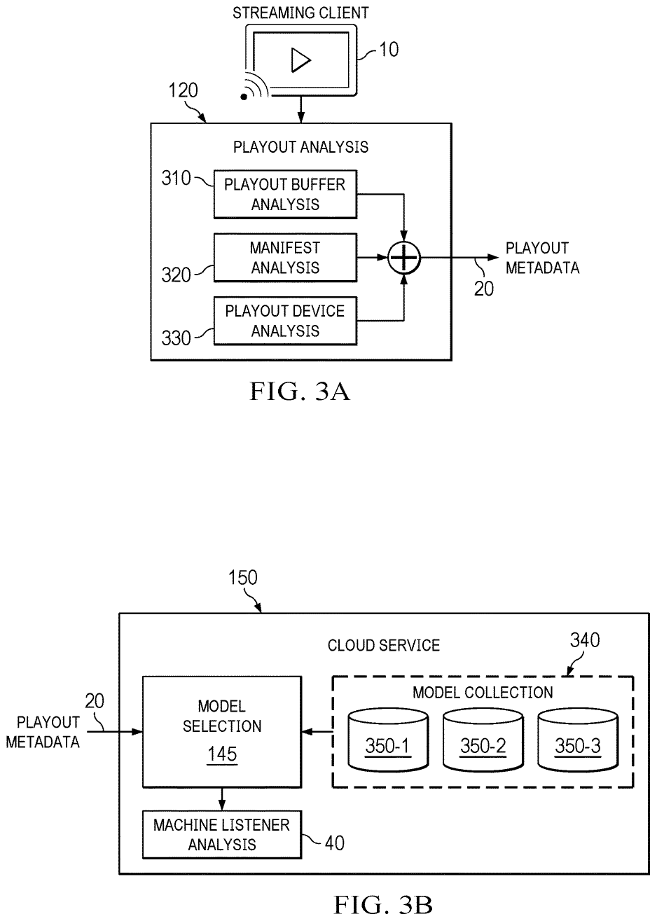

FIG. 3A illustrates an example of a streaming client 10 that collects playout-related information (e.g., playout-related metadata), which is then aggregated and sent upstream to facilitate operation of the quality assessment service 150 (e.g., machine listener service). FIG. 3A thus relates to operation of the instrumented client implemented or comprised by the streaming client 10.

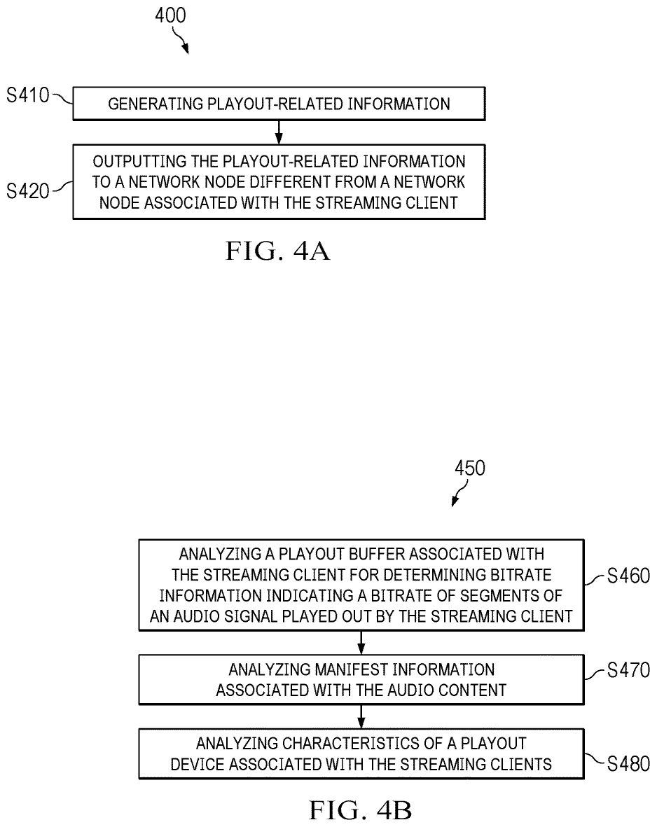

An example of a corresponding method 400 of providing playout-related information at a streaming client that processes audio content in an adaptive streaming environment is shown in the flowchart of FIG. 4A. Method 400, performed at the streaming client, comprises steps S410 and S420. Method 450 shown in the flowchart of FIG. 4B relates to details of step S410. Method 450 comprises steps S460 through S480.

At step S410, the playout-related information is generated.

At step S420, the playout-related information is output to a network node (e.g., test node) different from a network node associated with the streaming client. For example, as explained above, the playout related information may be output to the quality assessment service 150.

Method 400 may further comprise a step (not shown in the figure) of providing an indication of audio content processed by the streaming client, as described above in the context of FIG. 1.

Steps S460 through S480 of method 450 in FIG. 4B relate to details and potential implementations of step S410 in method 400. It is understood that step S410 may comprise one or more, potentially all, of steps S460 through S480.

At step S460, a playout buffer associated with the streaming client is analyzed for determining bitrate information indicating a bitrate of segments of an audio signal played out by the streaming client. Accordingly, the bitrate information may indicate respective bitrates for each of a plurality of sequential segments of the played-out content. Analysis of the playout buffer may also yield further information on a composition of the playout buffer, in addition to the bitrate information.

Here, it is understood that the playout buffer typically contains a sequence of segments. A change of bitrate may occur on a per-segment basis, for example due to an action of the ABR policy operating on the streaming client.

At step S470, manifest information associated with the audio content is analyzed. Analyzing the manifest information may yield information on the currently used bitrate ladder.

At step S480, characteristics of a playout device associated with the streaming clients are analyzed. Characteristics of the playout device may relate to a device type and/or a type of reproduction system used, for example headphone playout or speaker playout.

Thus, returning to FIG. 3A, playout analysis, for example by playout analysis block 120, may comprise one or more of playout buffer analysis (e.g., at Playout Buffer Analysis block 310), manifest analysis (e.g., at Manifest Analysis block 320), and playout device analysis (e.g., at Playout Device Analysis block 330).

Further, in accordance with the above, the playout-related information (e.g., metadata) may comprise information on a composition of a player buffer (e.g., determined by the Playout Buffer Analysis), composition of the currently used bitrate ladder (e.g., determined by Manifest Analysis), and/or an identification of the playout device (e.g., determined by Playout Device Analysis).

Operation and properties of the instrumented client associated with the streaming client 10 can be briefly summarized as follows.
Techniques according to the present disclosure require an instrumented client (which can be easily uploaded to the client device), but do not require any other operations (such as placing a reference on the client, for example).
The playout analysis extracts playout-relevant information (e.g., the sequence of segments in the playout buffer, information on the playout device, information on the content of the manifest) and sends it upstream as metadata.
The metadata can be used to recreate the test signal, or features of the test signal (e.g., spectrogram, such as Gammatone spectrograms), and can be used to perform a look up for a relevant reference signal. Given the two signals (i.e., test signal and reference signal), upon selection of an appropriately trained model, an indication of the quality score (e.g., probability distribution representing the quality score) may be computed by the quality assessment service 150.

Further, potential applications and advantages of the instrumented client and/or its operation may include the following:
The system may differentiate between different playout scenarios. For example, headphone playout may be in some cases more critical than speaker playout. This can be reflected in the quality score generated by a client. To achieve this, the cloud service performing the quality assessment may include a set of pretrained models. For example, there could be a model trained on listening test data from tests performed over headphones. There could be another model trained on listening tests performed over discrete speakers. Since the two playout scenarios generally differ in terms of how critical they are, it may be beneficial to use dedicated models for these scenarios, and then use an appropriate model to perform evaluation of playout quality.

FIG. 3B is a block diagram schematically illustrating an example process of selection of a model (from a set of pretrained models) that can be used by the quality assessment service 150 (e.g., machine listener). The model selection is based on the playout-related information 20 sent upstream by the instrumented client 10.

For example, different models may have been trained based on different training data, relating to respective different use cases. In one embodiment, different models may have been trained for different device characteristics, for example for different device type and/or different reproduction systems (e.g., headphones or speakers).

Model selection may be performed at Model Selection block 145. Selection may be made from a collection of models 340, comprising individual models 350-1, 350-2, 350-3, Each of these models may relate to a machine listener or DNN trained for audio quality assessment under specific circumstances. For example, the models in the collection of models 340 may have been trained for different device characteristics, as described above.

Returning to method 200 of FIG. 2, the audio quality assessment algorithm employed by this method may use a set of pretrained models for audio quality assessment. Then, at step S203, determining (e.g., generating) the estimate of the audio quality may comprise selecting a pretrained model among the set of pretrained models based on the playout-related information.

For instance, as explained above, the playout related information 20 may comprise information relating to a playout device associated with the streaming client. Then, the pretrained model may be selected based on the information relating to the playout device. The information relating to the playout device may include an indication of the playout device (e.g., headphones, soundbar, discrete speakers, etc.) and/or an indication of characteristics of the playout conditions (e.g., SNR, etc.).

In some embodiments, the quality assessment service may relate to a generative machine listener (e.g., stereo generative machine listener), implemented by a DNN, using (e.g., as the aforementioned audio quality assessment algorithm) the algorithm described below under section MACHINE LISTENER. This algorithm may operate on spectrograms (e.g., Gammatone spectrograms) computed from or for the test and reference signals, instead of operating directly on the waveforms. This means that both the test and the reference signals can be assembled from precomputed blocks (e.g., precomputed blocks of spectrograms), which can reduce cloud storage requirements and computational load. This is of particular advantage from the point of view reducing the cost of running the machine listener in a cloud.

The spectrograms (or other audio features) may be computed on per-segment basis according to the segmentation introduced by the transport mechanism that is used by the content delivery system (e.g., by CDN 105).

Thus, the (stereo) generative listener may operate on the Gammatone spectrograms of left, right, mid, and side signals of reference and coded stereo signals (e.g., as described in [5]). Gammatone filters are a popular approximation to the filtering performed by the ear. Gammatone-based spectrogram can thus be considered as a more perceptually motivated representation than the traditional spectrogram. The Gammatone spectrograms of the audio signal may be calculated for example with a window size of 80 ms, hop size of 20 ms, and 32 frequency bands ranging from 50 Hz up to 24 kHz. The resulting Gammatone spectrograms of short segments (e.g., 1 second of signal in ABR ladder) of reference and coded signals can be precomputed, paired and stacked along channel dimension, which results in an input size of 8×32×50 (channels×bands×time-frame) to the neural network, for example.

Thus, in some embodiments, the aforementioned representation of the estimate of the test audio signal and the aforementioned representation of the reference audio signal may each relate to one or more Gammatone spectrograms (e.g., Left (L), Right (R), Mid (M), and Side(S) spectrograms).

However, it is understood that techniques (e.g., methods and apparatus) according to the present disclosure are not limited to using spectrograms (e.g., Gammatone spectrograms), but that these techniques may likewise operate on waveforms or other audio features. Also, spectrograms other than Gammatone spectrograms may be used for this purpose, such as other perceptually motivated spectrograms. Nevertheless, for conciseness of presentation, without intended limitation, reference will be made in the following to spectrograms, in particular, Gammatone spectrograms, instead of generic spectrograms or waveforms.

FIG. 5 schematically illustrates the processes of assembling the reference signal and reconstructing the test signal based on playout-related information 20 (e.g., metadata) that is sent upstream to the quality assessment service 150 by the instrumented client 10. In some embodiments, the data flow process used to feed the quality assessment model (e.g., generative listener model, such as trained network 40 in FIG. 1) may include several precomputed steps.

Precomputed spectrograms (e.g., Gammatone spectrograms) are held, on a per segment basis, in reference repository 580. Based on the indication of the (segments of the) audio content played out by the streaming client 10 (e.g., ID and segmentation of content item played out), the reference repository 580 is queried by Reference Lookup block 585 for assembly of the reference signal, segment by segment, at Assemble Reference block 590. The assembled reference signal 560 is provided to the audio quality assessment algorithm, such as the machine listener, for audio quality assessment at Machine Listener Analysis block 540.

Further, the playout-related information 20, together with the indication of the (segments of the) audio content played out by the streaming client 10 (e.g., ID and segmentation of content item played out) is provided to Assemble Test Signal block 575. Based on the playout-related information 20 (e.g., bitrate, codec config), a content repository 570 is queried to assemble the test signal, again segment by segment. This yields the aforementioned representation of the test audio signal 530, for input to the audio quality assessment algorithm, such as the machine listener, for audio quality assessment at Machine Listener Analysis block 540. Assembly of the representation of the test audio signal 530 may correspond to step S220 of method 200, for example.

Although not shown in FIG. 5, it is understood that the playout-related information 20 may also be provided to Machine Listener Analysis block 540, for model selection as described above.

Based on the assembled representation of the test audio signal 530 and the assembled reference signal 560, the audio quality assessment algorithm can generate the estimate of the audio quality of the test audio signal, as explained above with reference to step S230 of method 200.

FIG. 6 is a non-limiting example of a graphical user interface showing the results provided by techniques according to embodiments of the disclosure. The GUI comprises indicators/selectors of available levels of the bitrate ladder 610 through 650, as well as an indication 660 of the audio score for the test signal. This indication 660 may comprise, for example, a mean and a confidence interval for a subjective listening score, such as a MUSHRA score, for example.

### Downstream Applications for Estimates of Audio Quality

Techniques according to the present disclosure can operate in an online and an offline setting.

In the online setting, the quality analysis may be performed on the fly and the performance score (e.g., the estimate of audio quality) can be distributed wherever it is needed in the delivery system.

The offline setting comprises aggregation of the playout-related information (e.g., playout metadata) from multiple streaming clients (e.g., two sets of clients used for AB testing). The test signals can be constructed in an offline manner (e.g., after the experiment is finished) from the collected playout-related information. The quality assessment service (e.g., machine listener) can then perform quality analysis offline, providing the performance statistics for the clients (or sets of clients).

In general, regardless of whether the online setting or the offline setting applies, techniques according to the present disclosure can be used for comparing streaming clients in different populations of streaming clients, or for comparing different populations of streaming clients.

An example of a corresponding method 700 is schematically illustrated in the flowchart of FIG. 7. Method 700 comprises steps S710 and S720 and may be performed subsequent to or in conjunction with method 200 described above.

At step S710, estimates of audio quality of test audio signals for streaming clients in each of a plurality of populations of streaming clients are determined. This may be done as described above in the context of method 200.

At step S720, the estimates of audio quality determined for the plurality of populations of streaming clients are compared to each other. In general, the determined estimates are analyzed.

Examples, application, and use cases of such comparison are schematically illustrated in the block diagrams of FIG. 8 and FIG. 9.

In the example of FIG. 8, a content server 850 (content origin) provides respective (audio) content 852, 854 to first and second content delivery networks CDN1, 830, and CDN2, 840. The first CDN 830 provides content 835 to a first population 810 of streaming clients 815. The second CDN 840 provides content 845 to a second population 820 of streamlining clients 825. Streaming clients of both populations 810, 820 provide respective sets of playout-related information 870, 880 to quality assessment service 860, which determines respective estimates of audio quality 865 (or estimates of playout performance in general) for the populations 810, 820, based on respective sets of playout-related information 870, 880, by techniques as set out above. Determining respective estimates of audio quality 865 may require receiving the downloaded segments 855 (provided to the streaming clients) or a representation thereof from the content server 850. Comparing the estimates of audio quality 865 for the two populations 810, 820 allows to infer information about different performances of the different CDNs 830, 840, for example. This information may be used to optimize content delivery to the populations of streaming clients.

In the example of FIG. 9, a content server 950 (content origin) provides (audio) content 952 to a CDN 910 which provides content 932 to a first population 910 of streaming clients 915 and provides content 934 to a second population 920 of streamlining clients 925. Streaming clients of both populations 910, 920 provide respective sets of playout-related information 970, 980 to quality assessment service 960, which determines respective estimates of audio quality 965 (or estimates of playout performance in general) for the populations 910, 920, based on respective sets of playout-related information 970, 980, by techniques as set out above. Determining respective estimates of audio quality 965 may require receiving the downloaded segments 955 (provided to the streaming clients) or a representation thereof from the content server 950. Comparing the estimates of audio quality 965 for the two populations 910, 920 of streaming clients allows to infer information about different performances of the different populations, for example in cases is which different delivery methods and/or playout methods are employed for/by the different populations. This information may be used to optimize content delivery to the populations of streaming clients and/or playout by the populations of streaming clients.

As a further application or use case, the proposed techniques may be used to provide a feedback loop for edge processing of content. For example, if the content encoder is located at the edge of the network, the estimated estimate of audio quality (e.g., MUSHRA score) could be used to fine-tune the bitrate ladder used to deliver audio content to a client.

An example of a framework involving such feedback loop is schematically illustrated in FIG. 10. A content server 1050 (content origin) provides (audio) content to an Encode and Packaging Coordination Engine 1090 (encoding and packaging engine) that encodes and packages content in accordance with a set of one or more rules, and provides the encoded and packaged content to a Point of Presence (POP) in CDN 1030 (or plural CDNs). The rules employed by the encoding and packaging engine 1090 may relate to maximizing a value function and/or minimizing a cost function, for example. For example, the one or more rules may relate to minimizing a number of levels in the bitrate ladder while optimizing an average (worst case) performance, and/or determining optimal bitrates for maximizing average (worst case) performance.

The CDN 1030 provides (audio) content to a population 1010 of streaming clients 1015, which in turn provide playout-related information 1070 to a quality assessment service 1060. The quality assessment service 1060 determines a playout performance for the population 1010 of streaming clients 1015 (e.g., an average playout performance, a worst-case playout performance, etc.) by techniques as set out above, and provides an indication of the determined playout performance to the encoding and packaging engine 1090.

In line with techniques described above, the playout performance may relate to the aforementioned estimates of audio quality, or a quantity derived therefrom.

Thus, in general, step S240 of method 200 described above may comprise or relate to outputting the determined estimate of the audio quality of the test audio signal (e.g., as a playout performance) to a network node for performing encoding and/or packaging of the audio content (e.g., the aforementioned encoding and packaging engine 1090).

Based on the playout performance 1065, the encoding and packaging engine 1090 in the example of FIG. 11 can then optimize encoding and/or packaging of the content.

For example, in a framework as shown in the example of FIG. 10, one or more of steps S1110 to S1130 of method 1100 shown in the flowchart of FIG. 11 may be performed.

Step S1110 relates to or comprises optimizing the encoding and/or packaging based on the estimate of the audio quality of the test audio signal.

Step S1120 relates to or comprises determining an optimal number of quality levels in a bitrate ladder for distribution by a content delivery network, based on the estimate of the audio quality of the test audio signal. This may involve inputting the estimate of the audio quality of the test audio signal to a utility function (e.g., value function and/or cost function) used for determining the optimal number of quality levels, for example.

Step S1130 relates to or comprises determining a configuration and/or set of coding tools based on the estimate of the audio quality of the test audio signal.

### Apparatus for Implementing Methods According to the Disclosure

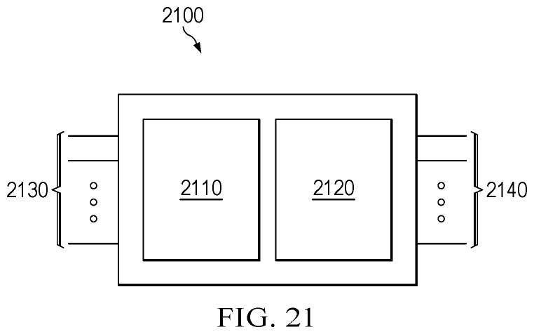

Finally, while reference above may be mainly made to methods according to the present disclosure, the present disclosure likewise relates to apparatus (e.g., computer-implemented apparatus) for performing methods and techniques described throughout the present disclosure. An example of such apparatus 2100, which is described in more detail below, is schematically illustrated in FIG. 21. Such an apparatus may implement, for example, the quality assessment service 150 or the (instrumented) streaming client 10. The apparatus (e.g., processor 2110 thereof) may receive, among others, suitable input data (e.g., playout-related information or an indication of audio content processed by a streaming client), depending on use cases and/or implementations. The apparatus 2100 (e.g., processor 2110 thereof) may be adapted to carry out the methods/techniques described throughout the present disclosure (e.g., method 200 of FIG. 2, method 400 of FIG. 4A, method 450 of FIG. 4B, method 700 of FIG. 7, and/or method 1100 of FIG. 11) and to generate corresponding output data 1240 (e.g., an estimate of an audio quality), depending on use cases and/or implementations.

The present disclosure likewise relates to corresponding computer programs and computer-readable storage media.

### Machine Listener

One non-limiting example for implementing the quality assessment service described above, or the algorithm employed by the quality assessment service, is a so-called machine listener (e.g., generative machine listener) as described in the following.

Broadly speaking, a machine listener (e.g., generative machine listener) according to embodiments of this disclosure is a neural network (e.g., deep neural network) trained to evaluate audio by comparing it to the relevant reference signal and providing the evaluation result, for example as a probability distribution of predicted listener scores in the currency of subjective listening tests such as Multi-Stimulus Tests with Hidden Reference and Anchor (MUSHRA).

In general, listener scores achieved for example in MUSHRA tests can be predicted by a system that takes the signal under test and the reference signal as inputs. Examples of such systems including neural networks are given in [5], which is hereby included by reference in its entirety.

For a given pair of input signals, there typically will be a certain degree of variability in the listener scores perceived by different listeners. It has been found that there is value in capturing that aspect of the data for automated estimation of quality of experience in entertainment delivery systems. In an actual subjective MUSHRA test, the mean and standard deviation of the listener scores obtained from different listeners can be computed, and the standard deviation can then be converted to a confidence interval given the number of listeners and a statistical model.

It has been found by the inventors to be challenging to train a neural network to directly output both mean values and confidence intervals. One feasible alternative for quantifying prediction variability may be to use a bootstrapping approach by training multiple models with the mean scores as objectives on randomly sampled subsets of the data. Each of the trained models will then introduce a slightly different prediction. The variability of these predictions then quantifies the level of confidence. However, the disadvantages of the bootstrapping method are twofold. First, using the bootstrapping method implies high complexity: one needs as many models as the number of listeners to be simulated. Second, there is a risk of modeling prediction variability rather than listener score distribution.

Another feasible alternative for quantifying prediction variability may be to consider separate modeling of the bias (see [1], [2]) or bias and inconsistency (see [3], [4]) of individual listeners across the signals under test. The main application of the latter method is prescreening of listeners with outlier behavior. A common inconvenience for these methods is that one needs to keep track of the listener identity in the dataset.

The present disclosure seeks to provide improved techniques for quantifying prediction variability of subjective listening tests. At the application stage (i.e., at inference) the trained model (e.g., generative model) according to the present disclosure provides a distribution of scores from which it is easy to extract mean scores as well as standard deviations and/or confidence intervals (CI) for any number of listeners.

At the training stage, unlike existing approaches where mean subjective scores are used as a target for training, the model according to the present disclosure utilizes individual listener scores. This has been found to simplify the preprocessing and allows the dataset to influence the training in direct proportion to the human effort for listening test data with varying number of listeners. Further, the maximum likelihood principle may be used for parameter estimation.

Techniques according to the present invention have been found to have the following advantages. The trained model (e.g., generative model) reaches similar performance as typical non-generative models in predicting the mean, but is also capable of predicting the confidence interval. Further, the trained model is more robust to conditions unseen in typical listening tests.

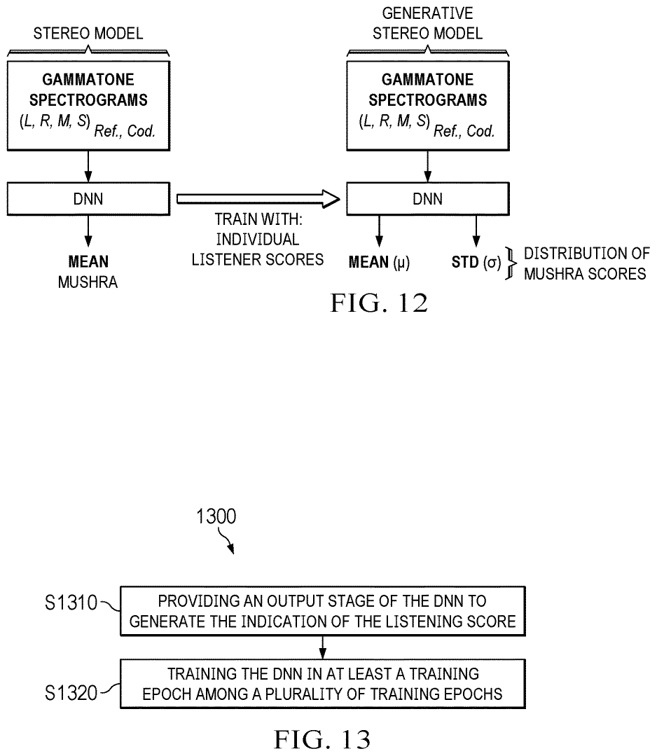

FIG. 12 shows a comparison between a conventional model (e.g., DNN) for predicting a mean listening score (e.g., MUSHRA score) and a model (e.g., DNN implementing the generative machine listener) according to embodiments of the disclosure. The conventional model (non-generative approach) shown on the left-hand side, given ref-coded audio (or features thereof, such as Gammatone spectrograms) predicts a mean subjective listening score (e.g., MUSHRA score). On the other hand, the generative machine listener model shown on the right-hand side provides a distribution of listening scores (e.g., MUSHRA scores). At training, the present disclosure proposes to utilize individual listening scores. Without intended limitation, the architecture of the DNN implementing the generative machine listener may be the one described in [5], with the difference that the output stage is configured to provide for more than one output, for example suitable for representing the distribution of listening scores (e.g., MUSHRA scores).

### DESCRIPTION OF EXAMPLE EMBODIMENTS

Given an original signal x and a signal under test y the generative listener model (or the DNN implementing same) gives an indication of a probability distribution of (subjective) listening scores (e.g., MUSHRA scores) s for y, for example as a parametrized probability density

$${p}_{θ} ( s \vert x , y ) \qquad ( 1 )$$

The parameters θ of the model are trained by the maximum likelihood principle. One can then simulate a listening test with N listeners by sampling the model N times. The negative log likelihood (NLL) loss, used for training of the model parameters θ for a listener score value s in the dataset may be −log p_{θ}(s|x, y).

In general, at the training stage, the input is given by training data items, each indicative of a respective value of the listening score s. The loss function depends on the indication of the listening score s. The training data items may each be further indicative of a representation of the audio signal (signal under test y) and a representation of the reference audio signal (original signal x) for the audio signal. Here, the representation of the audio signal y and the representation of the reference audio signal x may relate to Gammatone spectrograms, for example. Each training data item may be obtained by performing a standardized listening test (e.g., MUSHRA test) for a test signal y and a corresponding reference signal x, yielding the listening score s. Performing such test multiple times, for example with different listeners, will yield multiple training data items, tentatively denoted as (s,y,x). Test signals y and corresponding reference signals x may be obtained from suitable audio libraries, for example. Here and in the remainder of the disclosure, it is understood that the reference signal corresponds to an uncoded signal. The test audio signal corresponds to a coded audio signal (e.g., a signal obtained after encoding, decoding, and if necessary, time alignment with the reference signal for compensating coding delays).

If the representation of the test signal y and the reference signal x relate to Gammatone spectrograms (typically, L, R, M, and S spectrograms), each actual sound signal may yield 4 training data items (e.g., one per L, R, M, and S spectrogram).

An example of a method 1300 of configuring (e.g., training) a DNN for estimating an indication of a subjective listening score for an audio signal is illustrated by the flowchart of FIG. 13. Method 1300 comprises steps S1310 and S1320.

It is understood that the DNN implements the model (e.g., generative model) under consideration. For example, the DNN may implement the aforementioned generative machine listener.

Further, the listening score to be estimated or predicted by the DNN may be a score according to a predefined (e.g., standardized) listening test. The listening test may apply a predefined test metric and/or test scenario. One example of such listening test is a MUSHRA listening test.

At step S1310, an output stage of the DNN to generate the indication of the listening score is provided.

At step S1320, the DNN is trained, in (at least) a training epoch among a plurality of training epochs.

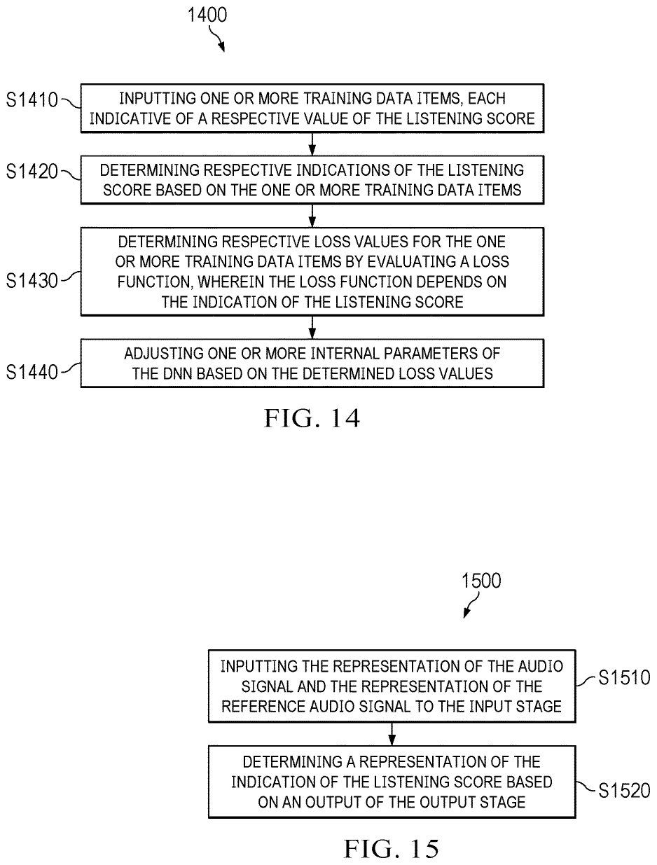

Method 1400 as illustrated by the flowchart of FIG. 14 is an example of a possible implementation of training the DNN, at step S1320, in a training epoch among the plurality of training epochs. Method 1400 comprises steps S1410 to S1440.

At step S1410, one or more training data items are input. For example, a mini batch of training data items (e.g., 8 training data items) may be input. As described above, each training data item is indicative of a respective value of the listening score s. As also described above, each training data item may be further indicative of a representation of the audio signal (signal under test y) and a representation of the reference audio signal (original signal x) for the audio signal.

At step S1420, respective indications of the listening score are determined based on the one or more training data items. These indications may be determined, for example, based on the representation of the audio signal and the representation of the reference audio signal.

In some embodiments, the indication of the listening score may relate to a probability distribution (e.g., probability density function) of the listening score, with the output stage being adapted for generating the probability distribution of the listening score. This probability distribution (e.g., pe (s|x, y) as per Eq. (1)) may emulate listening scores obtained by a plurality of (independent) listening tests for the audio signal. Further, the probability distribution may be parameterized by two or more parameters of the probability distribution. Examples for possible parameterizations of the probability distribution will be described below.

If the indication of the listening score relates to the probability distribution of the listening score, determining respective indications of the listening score based on the one or more training data items may comprise determining respective parameters of the probability distribution based on the one or more training data items. Here, determining the parameters of the probability distribution may be based at least in part on the value of the subjective listening score included in the training data item. Further, determining the parameters of the probability distribution may be based on a current state of the DNN, for example the current values of internal parameters of the DNN.

At step S1430, respective loss values for the one or more training data items are determined by evaluating a loss function. This loss function depends on the indication of the listening score.

In some embodiments, if the indication of the listening score relates to the probability distribution of the listening score, the loss function may depend on the parameters of the distribution. Examples of loss functions will be described below.

At step S1440, one or more internal parameters of the DNN are adjusted based on the determined loss values, for example by using well-known regression and back-propagation techniques. The internal parameters of the DNN may be model parameters, for example, such as coefficients (e.g., filter coefficients) of a plurality of layers of the DNN.

If multiple training data items are input per training epoch, adjusting the internal parameters may be based on an aggregate of the loss values for the training data items, such as a mean or average thereof, for example.

As noted above, training the DNN, for example via method 1400, may be based on the maximum likelihood principle. Accordingly, the loss function employed for the training (e.g., the loss function evaluated at step S1430 of method 1400) my relate to a negative log likelihood (NLL) loss. As also noted above, the negative log likelihood loss may be given by

$${L}_{NLL} = - log {p}_{θ} ( s \vert x , y ) , \qquad ( 2 )$$

where p_{θ}(s|x, y) is the probability density function (as an example of a probability distribution) for test score s given a representation of the audio signal y and a representation of a reference audio signal x for the audio signal y, and 0 indicates the internal parameters of the DNN.

A first non-limiting example of the probability density function pe (s|x, y) is that of a Gaussian distribution parametrized by mean μ and variance σ². The NLL loss may then be given by, for example

$${L}_{gauss} = \frac{1}{2} log 2 π + log σ + \frac{{( s - μ )}^{2}}{2 {σ}^{2}} , \qquad ( 3 )$$

with a parametrization via μ=p_{θ}(x,y) and log σ=f_{θ}(x,y) for training.

Thus, the probability distribution at step S1420 of method 1400 may relate to a Gaussian distribution parameterized by a mean μ and a variance σ². Then, the loss function L_{Gauss} may be given by

$${L}_{Gauss} = log σ + \frac{{( s - μ )}^{2}}{2 {σ}^{2}} + c ,$$

where c is a constant and s is the subjective listening score. The constant c may be given by

$$c = \frac{1}{2} log 2 π ,$$

for example, in line with Eq. (3).

A second non-limiting example of the probability density function p_{θ}(s|x, y) is that of a logistic distribution parametrized by mean μ and scale a. The NLL loss in this case may be given by, for example

$${L}_{logistic} = log 4 + log a + 2 log sech ( \frac{s - μ}{2 a} ) , \qquad ( 4 )$$

with a parametrization via μ=μθ(x,y) and log a=f_{θ}(x,y) for training.

Thus, the probability distribution at step S1420 of method 1400 may relate to a logistic distribution parameterized by a mean u and a scale a. Then, the loss function L_{logistic} may be given by

$${L}_{logistic} = log a + 2 log sech ( \frac{s - μ}{2 a} ) + c ,$$

where c is a constant and s is the subjective listening score. The constant c may be given by c=log 4, for example, in line with Eq. (4).

Models with more than two parameters, such as mixtures of Gaussians or logistics, or even categorical distributions, may have the capability to model multimodal listener score distributions. On the other hand, there is a potential drawback of requiring more data for successful training.

At inference, an estimate of an indication of a subjective listening score for an audio signal can be determined using an appropriately trained DNN, for example a DNN trained as described above. As above, the listening score is assumed to be a score according to a predefined listening test. Further, the DNN is in general assumed to comprise an input stage for receiving a representation of the audio signal and a representation of a reference audio signal for the audio signal, a plurality of layers for performing processing based on the representation of the audio signal and the representation of the reference audio signal, and an output stage, coupled to a last one of the plurality of layers, for generating the indication of the listening score. Here, processing by the plurality of layers may be further based on a current state of the DNN, for example the current values of internal parameters of the DNN.

An example of a corresponding method 1500 using this DNN is illustrated in the flowchart of FIG. 15. Method 1500 comprises steps S1510 and S1520.

At step S1510, the representation of the audio signal and the representation of the reference audio signal are input to the input stage of the DNN.

At step S1520, a representation of the indication of the listening score is determined based on an output of the output stage of the DNN.

As above, the indication of the listening score may relate to a probability distribution of the listening score, with the output stage of the DNN being adapted for generating the probability distribution of the listening score. This probability distribution may be seen as emulating listening scores obtained by a plurality of listening tests for the audio signal. Further, the probability distribution may be parameterized by two or more parameters of the probability distribution. Thus, the representation of the indication of the listening score determined at step S1520 may relate to the parameters of the probability distribution, for example.

Also, having available the output of the output stage of the DNN, the representation of the probability distribution may be determined for example via determining at least one of a mean, a standard deviation, and a confidence interval from the output of the output stage.

For instance, the confidence interval may be determined based on the output of the output stage and a number of listeners to the listening test to be emulated. Referring to the above example of a Gaussian parameterization of the probability distribution, once the parameter σ has been determined, the 95% confidence interval (CI₉₅) can be computed as

$${CI}_{95} = 1.96 \frac{σ}{\sqrt{N}} . \qquad ( 5 )$$

It is understood that an analogous determination can be applied to the case of a parametrization of the probability distribution as a logistic distribution, based on the scale a.

Further to the methods described above, the present disclosure likewise relates to a DNN for estimating an indication of a subjective listening score for an audio signal. Again, the listening score may be a score according to a predefined listening test, such as a MUSHRA test, for example. Such a DNN may comprise an input stage for receiving a representation of the audio signal (e.g., one or more Gammatone spectrograms) and a representation of a reference audio signal for the audio signal (e.g., one or more Gammatone spectrograms), a plurality of layers for performing processing based on the representation of the audio signal and the representation of the reference audio signal, and an output stage for generating the indication of the listening score. It is understood that a first one of the plurality of layers is coupled to the input stage and that a last one of the plurality of layers is coupled to the output stage. Processing by the plurality of layers may be further based on a current state of the DNN, for example the current values of internal parameters of the DNN.

It is understood that the DNN may be implemented by any suitable computing system, such as the apparatus shown in FIG. 21, for example.

Further, the DNN may have been configured (e.g., trained) by training the DNN in accordance with method 1400 described above.

In particular, the DNN may have been trained by, in a training epoch among a plurality of training epochs: inputting one or more training data items, each indicative of a respective value of the listening score, determining respective indications of the listening score based on the one or more training data items, determining respective loss values for the one or more training data items by evaluating a loss function, wherein the loss function depends on the indication of the listening score, and adjusting one or more internal parameters of the DNN based on the determined loss values.

As above, the indication of the listening score may relate to a probability distribution of the listening score, with the output stage of the DNN being adapted for generating the probability distribution of the listening score. This probability distribution may emulate listening scores obtained by a plurality of listening tests for the audio signal, and may be parameterized by two or more parameters of the probability distribution. For example, the probability distribution may relate to a Gaussian distribution parameterized by a mean u and a variance σ² or to a logistic distribution parameterized by a mean u and a scale a, as described above.

When the indication of the listening score relates to a probability distribution of the listening score, determining respective indications of the listening score based on the one or more training data items may comprise determining respective parameters of the probability distribution based on the one or more training data items, for example based at least in part on the value of the subjective listening score. Further in this case, the loss function will depend on the parameters of the distribution. It is also understood that determining the parameters of the probability distribution may be based on a current state of the DNN, for example the current values of internal parameters of the DNN.

### Simulated Results on an Example Test Set

Two stereo listening tests were considered as a test set. One listening test tests low bitrate codecs, and the other tests high bitrate codecs. A strategy has been devised for selecting the best model out of several models from the trained epochs.

The following factors may be taken into consideration during model selection:
The stability of the training process. For example, in general, the model trained with logistic distribution shows a smoother training and validation loss decay than the Gaussian distribution under the same settings. But Gaussian still could be a promising option if the training process is fine-tuned with techniques like gradient clipping.
Pearson Correlation Coefficient (PCC) between predicted mean MUSHRA score and actual mean MUSHRA listening test score. Higher PCC (close to 1) is preferred.
The NLL loss of training and validation set. For example, a model trained with a Gaussian distribution shows much smaller NLL loss than a model trained with logistic distribution.

Taking the above-mentioned aspects into account, several models were selected (from different epochs, i.e., from different stages of training; for either Gaussian or logistic) with the highest PCC on the validation set, lower training NLL losses, and a moderately lower validation loss. For models with similar PCC scores, the models with lower training NLL loss were kept (which is typically the model produced at the later epochs), but a moderately lower validation NLL loss. The reason for the latter is because it has been found that the model with the least validation loss does not necessarily show the best performance in predicting the confidence interval on test sets.

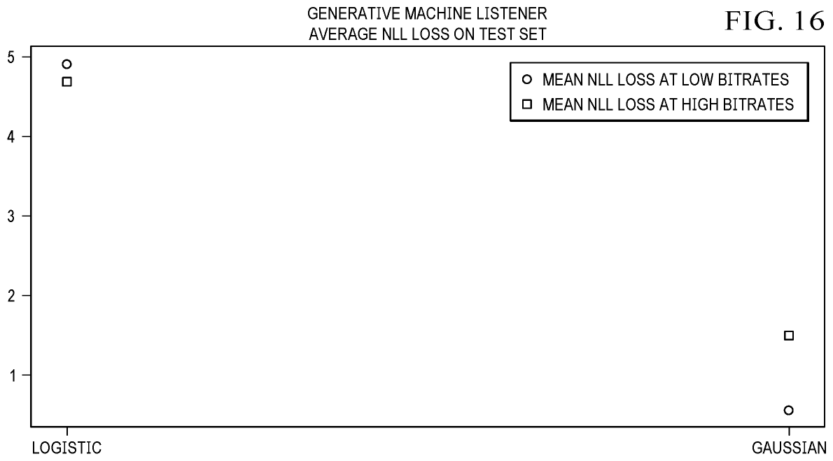

FIG. 16 is a plot showing examples of the mean NLL loss on the two listening tests with Gaussian and logistic distributions. Overall, logistic shows higher NLL-loss than the Gaussian model on the test sets. However, the lower loss does not necessarily mean better models (e.g., visually the logistic model shows a closer fit to the ground truth).

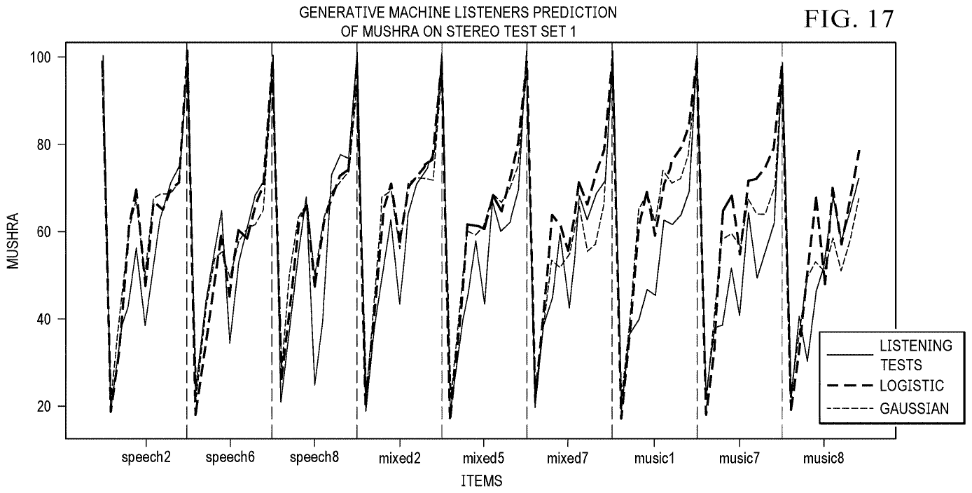

For the plots shown in FIG. 17 through FIG. 20, each excerpt has a reference, 3.5 kHz anchor, and 7 kHz anchor, followed by different coded representations.

FIG. 17 is a plot showing example results of the stereo low bitrate test. Specifically, the plot shows accuracy of predicting the mean MUSHRA score with the generative machine listener trained with logistic and Gaussian distribution for different classes of audio (3 speech, music, and mixed excerpts).

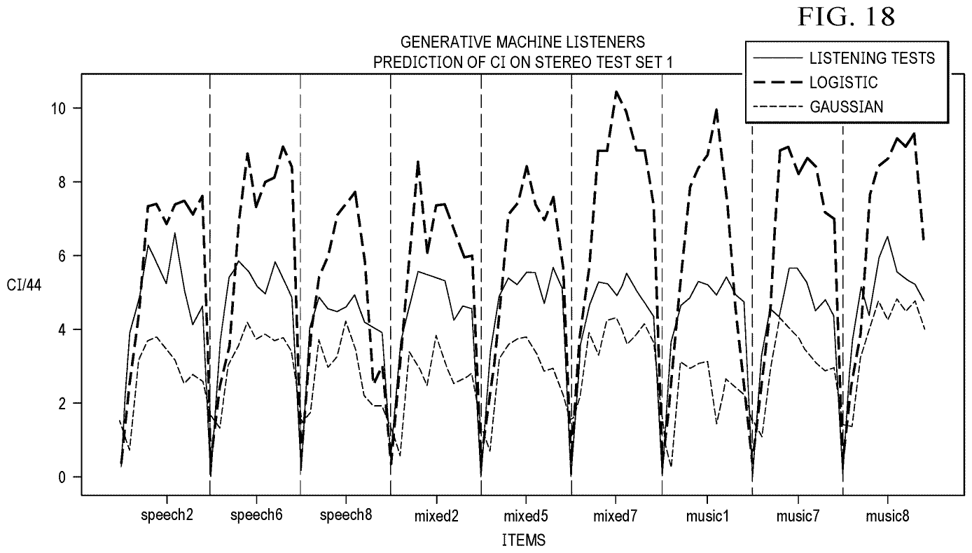

FIG. 18 is another plot showing example results of the stereo low bitrate test Specifically, the plot shows accuracy of predicting the CI with the generative machine listener trained with logistic and Gaussian distribution for different classes of audio (3 speech, music, and mixed excerpts) with 44 listeners.

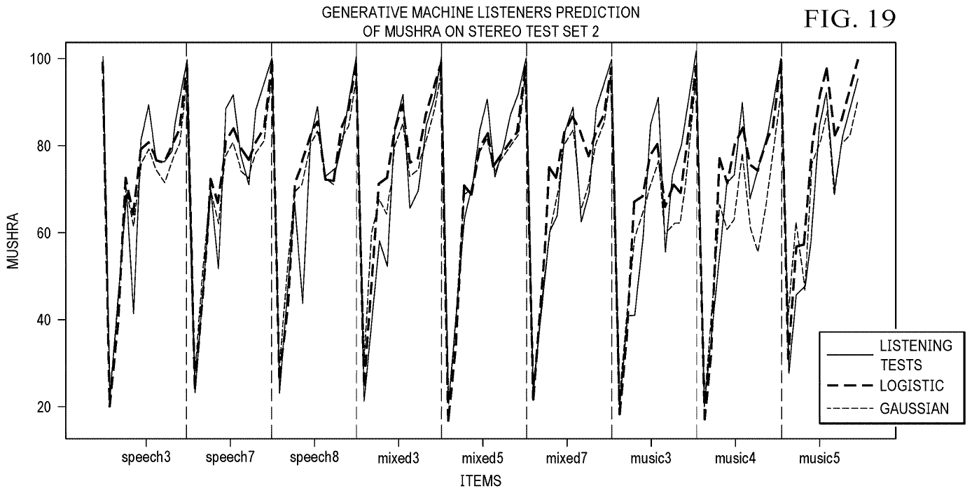

FIG. 19 is a plot showing example results of the stereo high bitrate test. Specifically, the plot shows accuracy of predicting the mean MUSHRA score with the generative machine listener trained with logistic and Gaussian distribution for different classes of audio (3 speech, music, and mixed excerpts).

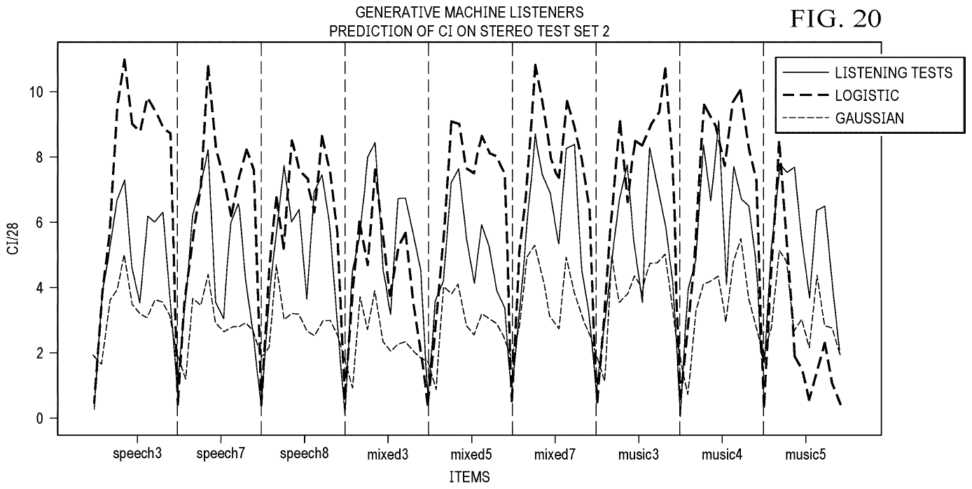

Finally, FIG. 20 is a plot showing example results of the stereo high bitrate test. Specifically, the plot shows accuracy of predicting the CI with the generative machine listener trained with logistic and Gaussian distribution for different classes of audio (3 speech, music, and mixed excerpts) with 28 listeners.

Pearson correlation (PC) evaluates the linear relationship between two continuous variables. For the examples shown in the above plots of FIG. 17 through FIG. 20, the trend for predicting the CI is closer to ground truth (i.e., CI from listening test) with the model trained with logistic distribution (PC=0.8190) than with Gaussian distribution (PC=0.6733). For high bitrates, both logistic distribution (PC=0.6461) and Gaussian distribution (PC=0.6700) are on par.

For predicting the mean, both the models perform on par in the above examples. For the low bitrate test, the model trained with logistic distribution has PC=0.9172, and Gaussian distribution has PC=0.9183. For the high bitrate test, the model trained with logistic distribution has PC=0.9316, and Gaussian distribution has PC=0.9375.

Spearman correlation (SC) evaluates the monotonic relationship. The Spearman correlation coefficient is based on the ranked values for each variable rather than the raw data. It measures rank preservation. For the low bitrate test, the model trained with logistic distribution has SC=0.8991, and Gaussian distribution has SC=0.8716 in the above examples. For the high bitrate test, the model trained with logistic distribution has SC=0.9297, and Gaussian distribution has SC=0.9360.

It can be noted that in subjective scores, references, low-pass anchors, and in general bitrates associated with higher quality are rated with low CI, and bitrates associated with lower quality are rated with higher CI. Unlike the aforementioned bootstrapping approach, where higher CI is associated with more dense data points in the training set (and vice-versa), techniques according to the present disclosure model the diversity of the listener scores.

### Apparatus for Implementing Methods According to the Disclosure

Finally, while reference above may be mainly made to methods according to the present disclosure, the present disclosure likewise relates to apparatus (e.g., computer-implemented apparatus) for performing methods and techniques described throughout the present disclosure. An example of such apparatus 2100 is schematically illustrated in FIG. 21. Such an apparatus 2100 may implement, for example, the deep neural network (machine listener) described above. The apparatus 2100 comprises a processor 2110 and a memory 2120 coupled to the processor 2110. The memory 2120 may store instructions for the processor 2110. The processor 2110 may also receive, among others, suitable input data (e.g., suitable training data at the training stage, or suitable test and reference audio signals at inference), depending on use cases and/or implementations. The processor 2110 may be adapted to carry out the methods/techniques described throughout the present disclosure (e.g., method 1300 of FIG. 13, method 1400 of FIG. 14, or method 1500 of FIG. 15) and to generate corresponding output data 1240 (e.g., an indication of a listening score), depending on use cases and/or implementations. For example, the apparatus 2100 may implement a method of training the DNN described above, or it may implement the (trained) DNN described above.

The present disclosure likewise relates to corresponding computer programs and computer-readable storage media.

### Interpretation

Aspects of the systems described herein may be implemented in an appropriate computer-based audio processing network environment (e.g., server or cloud environment) for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, the systems, services, clients, nodes, etc., described in the context of FIG. 1, FIG. 3A, FIG. 3B, FIG. 5, FIG. 8, FIG. 9, FIG. 10, FIG. 12 and/or FIG. 21 above can include or be implemented by one or more electronic processors, one or more computer-readable medium modules, one or more input/output interfaces, and various connections (e.g., a system bus) connecting the various components.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### Enumerated Example Embodiments

Various aspects and implementations of the present disclosure may also be appreciated from the following enumerated example embodiments (EEEs), which are not claims.

EEE1. A method for evaluating playout performance of adaptive streaming for a streaming client, wherein the method uses an objective quality assessment algorithm which emulates an intrusive quality test, wherein the method is implemented on a different network node than the client, wherein the method comprises: receiving playout related metadata from a client; using the metadata to reconstruct description of the test signal as required by the objective quality assessment algorithm; reconstructing description of the reference signal as required by the objective quality assessment algorithm; and computing the performance estimates and distributing them to other network nodes than the node, where the method operates.

EEE2. The method of EEE1, where the objective quality assessment algorithm uses a set of pretrained models and performs selection of a model based on the metadata received from a client.

EEE3. The method of EEE1 or EEE2, where the metadata received from the client comprises information that facilitates reconstruction of the description of the test signal required by the objective quality assessment tool at the network node implementing the method, for example: segment name and bitrate; and/or representation of a set of spectrograms (required by the objective quality assessment algorithm) computed based on the segment content.

EEE4. The method of EEE3, where the metadata received from the client comprises information on the playout device and/or playout conditions, for example: indication of a playout device (headphone, soundbar or discrete speakers); characteristics of the playout conditions (e.g., Signal to Noise ratio); and/or other.

EEE5. The method of any of the preceding EEEs, where the estimates provided by the method are used to compare at least two different populations of clients.

EEE6. The method of any of the preceding EEEs, where the performance estimates computed by the method are provided to a service optimizing encoding/packaging of the content.

EEE7. The method of EEE6, where the performance estimates are used as an input to a utility function used for determining an optimal number of quality levels in the bitrate ladder to be distributed on Points of Presence (PoPs) of a CDN.

EEE8. The method of EEE6, where the performance estimates are used to determine a tuning (e.g. configuration, set of coding tools) of the content encoder.

EEE-A1. A method of configuring a deep neural network, DNN, for estimating an indication of a subjective listening score for an audio signal, wherein the listening score is a score according to a predefined listening test, the method comprising:
providing an output stage of the DNN to generate the indication of the listening score; and
training the DNN by, in a training epoch among a plurality of training epochs: inputting one or more training data items, each indicative of a respective value of the listening score;
determining respective indications of the listening score based on the one or more training data items;
determining respective loss values for the one or more training data items by evaluating a loss function, wherein the loss function depends on the indication of the listening score; and
adjusting one or more internal parameters of the DNN based on the determined loss values.

EEE-A2. The method according to EEE-A1, wherein the indication of the listening score relates to a probability distribution of the listening score, with the output stage being adapted for generating the probability distribution of the listening score, wherein the probability distribution emulates listening scores obtained by a plurality of listening tests for the audio signal, and wherein the probability distribution is parameterized by two or more parameters of the probability distribution;
wherein determining respective indications of the listening score based on the one or more training data items comprises determining respective parameters of the probability distribution based on the one or more training data items; and wherein the loss function depends on the parameters of the distribution.

EEE-A3. The method according to EEE-A1 or EEE-A2, wherein training the DNN is based on a maximum likelihood principle.

EEE-A4. The method according to any one of the preceding EEE-As, wherein the loss function relates to a negative log likelihood, NLL, loss.

EEE-A5. The method according to EEE-A4 when depending on EEE-A2, wherein the negative log likelihood loss is given by L_{NLL}=−log p_{θ}(s|x, y), where pe (s|x, y) is the probability distribution for test score s given a representation of the audio signal y and a representation of a reference audio signal x for the audio signal y, and θ indicates the internal parameters of the DNN.

EEE-A6. The method according to EEE-A2 or any one of EEE-A3 to EEE-A5 when depending on EEE-A2, wherein the probability distribution relates to a Gaussian distribution parameterized by a mean u and a variance σ², and wherein the loss function L_{Gauss} is given by

$${L}_{Gauss} = log σ + \frac{{( s - μ )}^{2}}{2 {σ}^{2}} + c ,$$

where c is a constant and s is the subjective listening score.

EEE-A7. The method according to EEE-A2 or any one of EEE-A3 to EEE-A5 when depending on EEE-A2, wherein the probability distribution relates to a logistic distribution parameterized by a mean μ and a scale a, and wherein the loss function L_{logistic} is given by

$${L}_{logistic} = log a + 2 log sech ( \frac{s - μ}{2 a} ) + c ,$$

where c is a constant and s is the subjective listening score.

EEE-A8. The method according to any one of the preceding EEE-As, wherein the training data item is further indicative of a representation of the audio signal and a representation of a reference audio signal for the audio signal.

EEE-A9. The method according to EEE-A8, wherein the representation of the audio signal and the representation of the reference audio signal relate to Gammatone spectrograms.

EEE-A10. The method according to any one of the preceding EEE-As, wherein the predefined listening test is a Multi-Stimulus Test with Hidden Reference and Anchor, MUSHRA, listening test.

EEE-A11. The method according to any one of the preceding EEE-As, wherein the DNN implements a generative model.

EEE-A12. A method of estimating an indication of a subjective listening score for an audio signal using a deep neural network, DNN, wherein the listening score is a score according to a predefined listening test,
wherein the DNN comprises:
an input stage for receiving a representation of the audio signal and a representation of a reference audio signal for the audio signal;
a plurality of layers for performing processing based on the representation of the audio signal and the representation of the reference audio signal; and
an output stage for generating the indication of the listening score; and
wherein the method comprises:
inputting the representation of the audio signal and the representation of the reference audio signal to the input stage; and
determining a representation of the indication of the listening score based on an output of the output stage.

EEE-A13. The method according to EEE-A12, wherein the indication of the listening score relates to a probability distribution of the listening score, with the output stage of the DNN being adapted for generating the probability distribution of the listening score, wherein the probability distribution emulates listening scores obtained by a plurality of listening tests for the audio signal, and wherein the probability distribution is parameterized by two or more parameters of the probability distribution.

EEE-A14. The method according to EEE-A13, wherein determining the representation of the probability distribution comprises determining at least one of a mean, a standard deviation, and a confidence interval from the output of the output stage.

EEE-A15. The method according to EEE-A14, wherein the confidence interval is determined based on the output of the output stage and a number of listeners to the listening test to be emulated.

EEE-A16. The method according to any one of EEE-A13 to EEE-A15, wherein the probability distribution relates to a Gaussian distribution parameterized by a mean μ and a variance σ² or to a logistic distribution parameterized by a mean μ and a scale a.

EEE-A17. The method according to any one of EEE-A13 to EEE-A16, wherein the representation of the audio signal and the representation of the reference audio signal relate to Gammatone spectrograms.

EEE-A18. The method according to any one of EEE-A13 to EEE-A17, wherein the predefined listening test is a Multi-Stimulus Test with Hidden Reference and Anchor, MUSHRA, listening test.

EEE-A19. A deep neural network, DNN, for estimating an indication of a subjective listening score for an audio signal, wherein the listening score is a score according to a predefined listening test, the DNN comprising:
an input stage for receiving a representation of the audio signal and a representation of a reference audio signal for the audio signal;
a plurality of layers for performing processing based on the representation of the audio signal and the representation of the reference audio signal; and
an output stage for generating the indication of the listening score.

EEE-A20. The DNN according to EEE-A19, wherein the DNN has been configured by training the DNN by, in a training epoch among a plurality of training epochs:
inputting one or more training data items, each indicative of a respective value of the listening score;
determining respective indications of the listening score based on the one or more training data items;
determining respective loss values for the one or more training data items by evaluating a loss function, wherein the loss function depends on the indication of the listening score; and
adjusting one or more internal parameters of the DNN based on the determined loss values.

EEE-A21. The DNN according to EEE-A19 or EEE-A20, wherein the indication of the listening score relates to a probability distribution of the listening score, with the output stage of the DNN being adapted for generating the probability distribution of the listening score, wherein the probability distribution emulates listening scores obtained by a plurality of listening tests for the audio signal, and wherein the probability distribution is parameterized by two or more parameters of the probability distribution.

EEE-A22. The DNN according to EEE-A21 when depending on EEE-A20, wherein determining respective indications of the listening score based on the one or more training data items comprises determining respective parameters of the probability distribution based on the one or more training data items; and wherein the loss function depends on the parameters of the distribution.

EEE-A23. The DNN according to EEE-A21 or EEE-A22, wherein the probability distribution relates to a Gaussian distribution parameterized by a mean μ and a variance σ² or to a logistic distribution parameterized by a mean μ and a scale a.

EEE-A24. The DNN according to any one of EEE-A19 to EEE-A23, wherein the representation of the audio signal and the representation of the reference audio signal relate to Gammatone spectrograms.

EEE-A25. The DNN according to any one of EEE-A19 to EEE-A24, wherein the predefined listening test is a Multi-Stimulus Test with Hidden Reference and Anchor, MUSHRA, listening test.

EEE-A26. An apparatus comprising a processor and a memory coupled to the processor, and storing instructions for the processor, wherein the processor is adapted to carry out the method according to any one of EEE-A1 to EEE-A18.

EEE-A27. An apparatus comprising a processor and a memory coupled to the processor, and storing instructions for the processor, wherein the processor is adapted to implement the DNN according to any one of EEE-A19 to EEE-A25.

EEE-A28. A program comprising instructions that, when executed by a processor, cause the processor to carry out the method according to any one of EEE-A1 to EEE-A18.

EEE-A29. A program comprising instructions that, when executed by a processor, cause the processor to implement the DNN according to any one of EEE-A19 to EEE-A25.

EEE-A30. A computer-readable storage medium storing the program of EEE-A28 or EEE-A29.

EEE-B1. A method of evaluating playout performance in an adaptive streaming environment, the method comprising:
obtaining playout-related information from a streaming client;
estimating a representation of a test audio signal based on the playout-related information, wherein the test audio signal is an audio signal played out by the streaming client; and
determining, using an audio quality assessment algorithm, an estimate of an audio quality of the test audio signal based on the estimated representation of the test audio signal.

EEE-B2. The method according to EEE-B1, further comprising: generating a representation of a reference audio signal for the test audio signal.

EEE-B3. The method according to any one of the preceding EEE-Bs, further comprising: obtaining, from the streaming client, an indication of audio content processed by the streaming client.

EEE-B4. The method according to EEE-B3, wherein estimating the representation of the test audio signal is further based on the indication of the audio content.

EEE-B5. The method according to EEE-B3 or EEE-B4 when depending on EEE-B2, wherein generating the representation of the reference audio signal is based on the indication of the audio content.

EEE-B6. The method according to any one of the preceding EEE-Bs, wherein the playout-related information comprises bitrate information indicating a bitrate of the audio signal played out by the streaming client; and wherein estimating the representation of the test audio signal is based on the bitrate information.

EEE-B7. The method according to any one of the preceding EEE-Bs, wherein the audio quality assessment algorithm uses a set of pretrained models for audio quality assessment; and
wherein generating the estimate of the audio quality comprises selecting a pretrained model among the set of pretrained models based on the playout-related information.

EEE-B8. The method according to EEE-B7, wherein the playout related information comprises information relating to a playout device associated with the streaming client; and
wherein the pretrained model is selected based on the information relating to the playout device.

EEE-B9. The method according to any one of the preceding EEE-Bs, wherein the audio quality assessment algorithm is implemented by a deep neural network, DNN, for estimating an indication of a subjective listening score for the representation of a test audio signal as the estimate of the audio quality, wherein the listening score is a score according to a predefined listening test, the DNN comprising:
an input stage for receiving the representation of the test audio signal and a representation of a reference audio signal for the test audio signal;
a plurality of layers for performing processing based on the representation of the test audio signal and the representation of the reference audio signal; and
an output stage for generating the indication of the listening score.

EEE-B10. The method according to EEE-B9, wherein the DNN has been configured by training the DNN by, in a training epoch among a plurality of training epochs:
inputting one or more training data items, each indicative of a respective value of the listening score;
determining respective indications of the listening score based on the one or more training data items;
determining respective loss values for the one or more training data items by evaluating a loss function, wherein the loss function depends on the indication of the listening score; and
adjusting one or more internal parameters of the DNN based on the determined loss values.

EEE-B11. The method according to any one of the preceding EEE-Bs, wherein the method is implemented at a different network node than the streaming client.

EEE-B12. The method according to any one of the preceding EEE-Bs, wherein the representation of the estimate of the test audio signal relates to one or more Gammatone spectrograms.

EEE-B13. The method according to EEE-B2 or any EEE-B depending on EEE-B2, wherein the representation of the reference audio signal relates to one or more Gammatone spectrograms.

EEE-B14. The method according to any one of the preceding EEE-Bs, further comprising: outputting the estimate of the audio quality of the test audio signal to a network node different from a network node associated with the streaming client.

EEE-B15. The method according to any one of the preceding EEE-Bs, wherein
the estimate of the audio quality of the test audio signal is output to a network node for performing encoding and/or packaging of the audio content; and
the method further comprises optimizing the encoding and/or packaging based on the estimate of the audio quality of the test audio signal.

EEE-B16. The method according to EEE-B15, further comprising determining an optimal number of quality levels in a bitrate ladder for distribution by a content delivery network, based on the estimate of the audio quality of the test audio signal.

EEE-B17. The method according to EEE-B15 or EEE-B16, further comprising determining a configuration and/or set of coding tools based on the estimate of the audio quality of the test audio signal.

EEE-B18. The method according to any one of the preceding EEE-Bs, further comprising:
determining estimates of audio quality of test audio signal for streaming clients in each of a plurality of populations of streaming clients; and
comparing the estimates of audio quality determined for the plurality of populations of streaming clients.

EEE-B19. A method of providing playout-related information at a streaming client that processes audio content in an adaptive streaming environment, the method comprising:
generating the playout-related information by one or more of:
analyzing a playout buffer associated with the streaming client for determining bitrate information indicating a bitrate of segments of an audio signal played out by the streaming client;
analyzing manifest information associated with the audio content; and
analyzing characteristics of a playout device associated with the streaming clients; and
outputting the playout-related information to a network node different from a network node associated with the streaming client.

EEE-B20. An apparatus comprising a processor and a memory coupled to the processor, and storing instructions for the processor, wherein the processor is adapted to carry out the method according to any one of EEE-B1 to EEE-B19.

EEE-B21. A program comprising instructions that, when executed by a processor, cause the processor to carry out the method according to any one of EEE-B1 to EEE-B19.

EEE-B22. A computer-readable storage medium storing the program of EEE-B21.

### REFERENCES

[1] Y. Leng, X. Tan, S. Zhao, F. Soong, X.-Y. Li and T. Qin, “MBNET: MOS Prediction for Synthesized Speech with Mean-Bias Network,” ICASSP 2021, pp. 391-395
[2] W.-C. Huang, E. Cooper, J. Yamagishi, and T. Toda, “LDNet: Unified Listener Dependent Modeling in MOS Prediction for Synthetic Speech,” ICASSP 2022, pp. 896-900
[3] G. Mittag, S. Zadtootaghaj, T. Michael, B. Naderi and S. Möller, “Bias-Aware Loss for Training Image and Speech Quality Prediction Models from Multiple Datasets,” 2021 13th International Conference on Quality of Multimedia Experience (QoMEX), pp. 97-102
[4] Zhi Li, Christos G. Bampis, Lucjan Janowski, Ioannis Katsavounidis, “A Simple Model for Subject Behavior in Subjective Experiments” in Proc. Int'l. Symp. on Electronic Imaging: Human Vision and Electronic Imaging, 2020, pp 131-1-131-14, https://doi.org/10.2352/ISSN.2470-1173.2020.11.HVEI-131
[5] Co-pending patent application “Robust Intrusive Perceptual Audio Quality Assessment based on Convolutional Neural Networks”, applicant's docket No. D20118, filed as U.S. provisional patent application 63/119,318 and international patent application PCT/EP2021/083531, published as WO/2022/112594

1. A method of evaluating playout performance in an adaptive streaming environment, the method comprising:
obtaining playout-related information from a streaming client;
estimating a representation of a test audio signal based on the playout-related information, wherein the test audio signal is an audio signal played out by the streaming client; and
determining, using an audio quality assessment algorithm, an estimate of an audio quality of the test audio signal based on the estimated representation of the test audio signal, wherein the method is implemented at a different network node than the streaming client.

2. The method according to claim 1, further comprising:
generating a representation of a reference audio signal for the test audio signal.

3. The method according to claim 2, further comprising:
obtaining, from the streaming client, an indication of audio content processed by the streaming client.

4. The method according to claim 3, wherein estimating the representation of the test audio signal is further based on the indication of the audio content.

5. The method according to claim 3, wherein generating the representation of the reference audio signal is based on the indication of the audio content.

6. The method according to claim 1, wherein the playout-related information comprises bitrate information indicating a bitrate of the audio signal played out by the streaming client; and
wherein estimating the representation of the test audio signal is based on the bitrate information.

7. The method according to claim 1, wherein the audio quality assessment algorithm uses a set of pretrained models for audio quality assessment; and
wherein generating the estimate of the audio quality comprises selecting a pretrained model among the set of pretrained models based on the playout-related information.

8. The method according to claim 7, wherein the playout related information comprises information relating to a playout device associated with the streaming client; and
wherein the pretrained model is selected based on the information relating to the playout device.

9. The method according to claim 1, wherein the audio quality assessment algorithm is implemented by a deep neural network, DNN, for estimating an indication of a subjective listening score for the representation of a test audio signal as the estimate of the audio quality, wherein the listening score is a score according to a predefined listening test, the DNN comprising:
an input stage for receiving the representation of the test audio signal and a representation of a reference audio signal for the test audio signal;
a plurality of layers for performing processing based on the representation of the test audio signal and the representation of the reference audio signal; and
an output stage for generating the indication of the listening score.

10. The method according to claim 9, wherein the DNN has been configured by training the DNN by, in a training epoch among a plurality of training epochs:
inputting one or more training data items, each indicative of a respective value of the listening score;
determining respective indications of the listening score based on the one or more training data items;
determining respective loss values for the one or more training data items by evaluating a loss function, wherein the loss function depends on the indication of the listening score; and
adjusting one or more internal parameters of the DNN based on the determined loss values.

11. (canceled)

12. The method according to claim 1, wherein the representation of the estimate of the test audio signal relates to one or more Gammatone spectrograms.

13. The method according to claim 2, wherein the representation of the reference audio signal relates to one or more Gammatone spectrograms.

14. The method according to claim 1, further comprising: outputting the estimate of the audio quality of the test audio signal to a network node different from a network node associated with the streaming client.

15. The method according to claim 1, wherein the estimate of the audio quality of the test audio signal is output to a network node for performing encoding and/or packaging of the audio content; and
the method further comprises optimizing the encoding and/or packaging based on the estimate of the audio quality of the test audio signal.

16. The method according to claim 15, further comprising determining an optimal number of quality levels in a bitrate ladder for distribution by a content delivery network, based on the estimate of the audio quality of the test audio signal.

17. The method according to claim 15, further comprising determining a configuration and/or set of coding tools based on the estimate of the audio quality of the test audio signal.

18. The method according to claim 1, further comprising:
determining estimates of audio quality of test audio signals for streaming clients in each of a plurality of populations of streaming clients; and
comparing the estimates of audio quality determined for the plurality of populations of streaming clients.

19. A method of providing playout-related information at a streaming client that processes audio content in an adaptive streaming environment, the method comprising:
generating the playout-related information by one or more of:
analyzing a playout buffer associated with the streaming client for determining bitrate information indicating a bitrate of segments of an audio signal played out by the streaming client;
analyzing manifest information associated with the audio content; and
analyzing characteristics of a playout device associated with the streaming clients; and
outputting the playout-related information to a network node different from a network node associated with the streaming client.

20. An apparatus comprising a processor and a memory coupled to the processor, and storing instructions for the processor, wherein the processor is adapted to carry out the method according to claim 1.

21. A computer program comprising instructions that, when executed by a processor, cause the processor to carry out the method according to claim 1.

22. A non-transitory computer-readable storage medium storing the program of claim 21.
